(19) United States
(12) Patent Application Publication
(10) Pub. No.: US 2013/0166313 A1
(43) Pub. Date: Jun. 27, 2013

(54) SYSTEMS AND METHODS FOR MANAGING TREATMENT OF AN ORPHAN DISEASE

(71) Applicants: Edward Kitfield, Boston, MA (US); Marcio Souza, Tewksbury Twp, NJ (US); Karthik Kalyanam, Cambridge, MA (US); Sriram Subramanian, Cambridge, MA (US)

(72) Inventors: Edward Kitfield, Boston, MA (US); Marcio Souza, Tewksbury Twp, NJ (US); Karthik Kalyanam, Cambridge, MA (US); Sriram Subramanian, Cambridge, MA (US)

(73) Assignee: SHIRE HUMAN GENETIC THERAPIES, INC., Lexington, MA (US)

(21) Appl. No.: 13/638,986

(22) PCT Filed: Apr. 1, 2011
(86) PCT No.: PCT/US11/30976

§ 371 Date: Mar. 11, 2013

Related U.S. Application Data
(60) Provisional application No. 61/320,573, filed on Apr. 2, 2010.

(51) Int. Cl. G06F 19/00; G06Q 50/22

(52) U.S. Cl. CPC G06F 19/34; G06Q 50/22
USPC 705/2

(57) ABSTRACT

A system for managing treatment of an orphan disease of a patient by a user includes a mobile device and a program stored thereon. The mobile device is constructed and adapted to communicate with at least one server. The program stores one or more parameters related to the treatment of the orphan disease, tracks the parameters, and communicates information related to the treatment of the orphan disease with a health care provider, a company, and/or a case manager.

### RELATED APPLICATIONS

This application claims priority to U.S. Provisional Application Serial No. 61/320,573, entitled “SYSTEMS AND METHODS FOR MANAGING TREATMENT OF AN ORPHAN DISEASE,” filed on Apr. 2, 2010, which is herein incorporated by reference in its entirety.

### BACKGROUND

1. Technical Field

The present disclosure relates generally to the field of health care management.

2. Background

An individual with a chronic disease, including orphan diseases such as lysosomal storage disease, may be required to monitor various health parameters on a continuous basis in support of any treatment or therapy. One form of lysosomal storage disease is called Gaucher disease. Gaucher disease is a rare inherited disorder that affects specific cells and organs in the body. Gaucher disease occurs in people who do not produce enough of an enzyme called glucocerebrosidase. Without this enzyme, harmful amounts of a certain fatty substance (lipid) can build up in the liver, spleen, bones, bone marrow and nervous system, and can prevent cells and organs from working properly. About one in every 50,000 to 100,000 people in the general population have Gaucher disease, for which there is no cure.

Today, there is a range of therapeutic options available to treat Gaucher disease and its symptoms. Several therapies are intended to target the biochemical process of the disease. Also, options are available or are being developed for treating symptoms of the disease, such as pain, anemia, and joint problems.

Treatments for Gaucher disease include CEREZYME® by Genzyme Corporation of Cambridge, Mass., ZAVESCA® by Actelion Pharmaceuticals Ltd. of Allschwil/Basel, Switzerland, and VPRIV™ by Shire Human Genetic Therapies, Inc. (Shire HGT) of Cambridge, Mass. The VPRIV™ (velaglucerase alfa) treatment is a hydrolytic lysosomal glucocerebroside-specific enzyme that is indicated for the treatment of Gaucher disease in children and adults, and is approved by the U.S. Food and Drug Administration. It provides long-term enzyme replacement therapy for Type 1 Gaucher disease, the most common form of the genetic disorder, and is an alternative to CEREZYME® (imiglucerase), another enzyme replacement therapy.

Certain therapies for treating lysosomal storage disease, for example, velaglucerase alfa, may be administered by the patient, a family member, or a treatment facility under the direction of a health care professional. Because these treatments may occur outside the presence of a health care provider or other provider (e.g., between doctor visits), the patient or family member assumes responsibility for administration of the treatments. The patient may also require on-going support for managing the treatments between health care provider visits.

### SUMMARY OF INVENTION

An application for a mobile device, such as a smart phone having a processor and wireless networking capability, enables users to manage and track treatments of a disease, for example, a chronic disease (e.g., an orphan disease such as a disease described herein). In one implementation, the application includes software that is stored on a memory of the mobile device and executed by the processor.

One embodiment of the application includes a disease tracking feature that enables patients to record and review various parameter data related to their disease. The parameters may include testable and quantitatively measureable aspects of certain symptoms associated with the disease. For example, a symptom of pain may be recorded on a recurring basis (e.g., daily) by the patient ranking the extent of the pain on a fixed scale, such as 0 (for no pain) to 10 (severe pain). The application provides reports and/or graphs of the recorded data such that trends may be identified, or such that the data may be correlated with treatments for further evaluation.

Another embodiment of the application includes a calendar feature for scheduling administrations of treatments and/or appointments, for example, infusions and health care provider visits. For example, treatment of a disease may involve administration of a drug on a recurring basis, and the calendar feature allows the patient to schedule such administrations. The calendar feature may provide the user with a reminder for each scheduled administration or appointment.

In another embodiment, the application provides news and other information related to the disease and/or treatments, which is viewable on the mobile device. The news and other information may, for example, be received by the mobile device by wireless communication from, for example, a server or a website. The news and other information may, for example, be stored on the memory of the mobile device and displayed on a display of the mobile device when, e.g., selected by the user.

In yet another embodiment, the application provides a support feature that enables the user to communicate with, for example, a health care provider or case manager. For example, the user may use the support feature to request insurance and/or reimbursement assistance from the case manager. In other examples, the user may use the support feature to select a case manager from a list of case managers, to ask questions related to the treatment of the disease, and/or to request other support services.

According to one embodiment, a system for managing treatment of an orphan disease of a patient by a user includes a mobile device having a processor and a memory coupled to the processor. The mobile device is constructed and adapted to communicate with at least one server. A program is stored on the memory. The program is executable by the processor and comprises a data storage module for storing one or more parameters related to the treatment of the orphan disease, a tracking module for tracking the parameters, and a communications module for communicating information related to the treatment of the orphan disease with a health care provider, a company, and/or a case manager. The mobile device may be a smart phone having a wireless network device, or a personal digital assistant having a wireless network device. The information may include news, company alerts, and/or the parameters. The parameters and/or the information may be displayed to the user in an interface of the mobile device.

The program may also include a calendar module for scheduling treatment administrations and/or appointments. The information may include the treatment administrations and/or the appointments.

In an embodiment, the orphan disease may be a lysosomal storage disorder.

The treatment may include one or more of the following: enzyme replacement therapy, bone marrow transplantation, physical therapy, cord blood transplants, anticonvulsant medicine, adequate nutrition and hydration, techniques to keep airway open, gene therapy, controlling or reducing the symptoms associated with the orphan disease, nutrition supplements, physical therapy, speech therapy, surgery, cysteamine, sodium citrate, potassium and phosphorus supplements, conventional antipsychotic or antidepressant therapy, lithium salts, electroconvulsive therapy, spinal fusion, glucosylceramide synthase inhibitors, organ transplant, palliative treatment, a glycosylation independent lysosomal targeting (GILT) tagged human acid alpha-glucosidase (GAA), agalsidase beta, metoclopramide, dialysis, kidney transplantation, velaglucerase alfa, taliglucerase alfa, glucosylceramide synthase inhibitors, isofagomine tartrate, blood transfusion, joint replacement surgery, antibiotics, antiepileptics, bisphosphonates, substrate reduction therapy, corneal transplants, N-butyldeoxynojirimycin, proper nutrition and hydration, maintenance of clear airways, anticonvulsants, stem cell treatment, growth hormones, dental hygiene, physiotherapy, and hydrotherapy.

The parameters may include parameter data acquired from a medical test of the patient. The parameters may include a parameter type, a parameter value, and/or a test date. The parameter type may be bone pain, hemoglobin level, liver volume, platelet count, and/or spleen volume.

In another embodiment, a method for managing treatment of an orphan disease of a patient by a user using a mobile device includes storing, on a memory of the mobile device, one or more parameters related to the treatment of the orphan disease, tracking the one or more parameters, and communicating information related to the treatment of the orphan disease with a health care provider, a company, and/or a case manager. The mobile device may be a smart phone having a wireless network device, or a personal digital assistant having a wireless network device.

The information may include news, company alerts, and/or the parameters.

The method may also include scheduling treatment administrations and/or appointments. The appointments may be health care related. The information may include the treatment administrations and/or the appointments.

The method may also include displaying, to the user in an interface of the mobile device, the parameters and/or the information.

The orphan disease may be a lysosomal storage disorder. The treatment may include one or more of the following: enzyme replacement therapy, bone marrow transplantation, physical therapy, cord blood transplants, anticonvulsant medicine, adequate nutrition and hydration, techniques to keep airway open, gene therapy, controlling or reducing the symptoms associated with the orphan disease, nutrition supplements, physical therapy, speech therapy, surgery, cysteamine, sodium citrate, potassium and phosphorus supplements, conventional antipsychotic or antidepressant therapy, lithium salts, electroconvulsive therapy, spinal fusion, glucosylceramide synthase inhibitors, organ transplant, palliative treatment, a glycosylation independent lysosomal targeting (GILT) tagged human acid alpha-glucosidase (GAA), agalsidase beta, metoclopramide, dialysis, kidney transplantation, velaglucerase alfa, taliglucerase alfa, glucosylceramide synthase inhibitors, isofagomine tartrate, blood transfusion, joint replacement surgery, antibiotics, antiepileptics, bisphosphonates, substrate reduction therapy, corneal transplants, N-butyldeoxynojirimycin, proper nutrition and hydration, maintenance of clear airways, anticonvulsants, stem cell treatment, growth hormones, dental hygiene, physiotherapy, and hydrotherapy.

The parameters may include parameter data acquired from a medical test of the patient. The parameters may include a parameter type, a parameter value, and/or a test date. The parameter type may be bone pain, hemoglobin level, liver volume, platelet count, and/or spleen volume.

The method may also include displaying the parameters on a display of the mobile device.

In another embodiment, a computer readable storage medium embodies a program having instructions executable by a processor of a mobile device. The instructions are executed to perform a method for managing treatment of an orphan disease of a patient by a user including storing, on a memory of the mobile device, one or more parameters related to the treatment of the orphan disease, tracking the one or more parameters, and communicating information related to the treatment of the orphan disease with a health care provider, a company, and/or a case manager. The mobile device may be a smart phone having a wireless network device, or a personal digital assistant having a wireless network device. The method may also include scheduling treatments and/or appointments.

In another embodiment, a system for managing treatment of an orphan disease of a patient by a user includes a mobile device having a processor and a memory coupled to the processor, the mobile device constructed and adapted to communicate with at least one server, and a program stored on the memory. The program is executable by the processor and includes a news module for receiving and displaying news related to the orphan disease, where the news may be generated by a news provider and disseminated through the at least one server, a calendar module for scheduling treatments of the orphan disease and/or health related appointments, a tracking module for storing and displaying health related data of the patient, and a support module for exchanging messages between the patient and a case manager through the server. The mobile device may be a smart phone having a wireless network device, or a personal digital assistant having a wireless network device.

The news module may provide a news screen for displaying one or more headlines, a news feed screen for displaying a news story, and/or a company alert screen for displaying information generated by at least one of a company and a support service.

The calendar module may store and/or display at least one appointment related to the treatment of the orphan disease. Each appointment may be a one time appointment or a bi-weekly appointment.

The health related data may include parameter data acquired from a medical test of the patient. The parameter data may include a parameter type, a parameter value, and a test date.

The orphan disease may be a lysosomal disease. The parameter type may be bone pain, hemoglobin level, liver volume, platelet count, and/or spleen volume.

The tracking module may also store and/or display a weight, an age, and a gender of the patient. The tracking module may display parameter data in a tabular format and/or a graphical format.

The support module may store and/or display a list of case managers. The list of case managers may have a plurality of case manager names. The support module may store and/or display a patient profile. The patient profile may include a patient name, a patient street address, a patient telephone number, and/or a patient e-mail address. The support module may generate the messages based on the patient profile, the case manager, and/or a message type. The message type may be an address change notification, an insurance notification, and/or a vacation notification.

In another embodiment, a method for managing treatment of an orphan disease of a patient by a user using a mobile device includes scheduling, in a calendar stored on the mobile device, one or more appointments related to the treatment of the orphan disease, and tracking, in a repository stored on the mobile device, one or more parameters acquired from a medical test of the patient, each of parameters having a parameter type, a parameter value, and a test date.

The method may also include receiving, through a network interface of the mobile device, and displaying, through a graphical user interface of the mobile device, one or more news items related to the orphan disease. Each of the news items may include a news story and/or a company alert.

The method may also include communicating, through the network interface, one or more messages between the patient and a case manager.

Each of the appointments may include a one time appointment or a recurring appointment.

Tracking the parameters may include prompting a user to select a parameter type. In response to the parameter type being selected, tracking may include prompting the user to enter the parameter value, the parameter representing a discrete measurement of one parameter of the patient. In response to the parameter value being entered, tracking may include storing the parameter type, the parameter value, and/or the test date in the repository. Tracking may further include prompting the user to request a history of the parameters. In response to the history being requested, tracking may include retrieving at least one of the parameters from the repository, and displaying the retrieved parameter in a tabular and/or graphical format.

Any one of the messages may be an address change notification, an insurance notification, and/or a vacation notification.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic illustration showing exemplary relationships among entities in accordance with various embodiments of the disclosure.

FIG. 2 is a schematic illustration showing an exemplary system in accordance with one embodiment of the disclosure.

FIG. 3 is a schematic illustration showing an exemplary system in accordance with one embodiment of the disclosure.

FIG. 4 is a flow diagram showing an exemplary flow of data and other information in accordance with one embodiment of the disclosure.

FIGS. 5A-5E are a state diagrams representing one or more exemplary applications in accordance with various embodiments of the disclosure.

FIGS. 6 and 7 illustrate exemplary screen displays relating to an application in accordance with various embodiments of the disclosure.

FIGS. 8A-8G illustrate exemplary screen displays relating to a news feature of the application in accordance with various embodiments of the disclosure.

FIGS. 9A-9J illustrate exemplary screen displays relating to a calendar feature of the application in accordance with various embodiments of the disclosure.

FIGS. 10A-10N and FIGS. 10P-10Q illustrate exemplary screen displays relating to a tracker feature of the application in accordance with various embodiments of the disclosure.

FIGS. 11A-11E illustrate exemplary screen displays relating to a support feature of the application in accordance with various embodiments of the disclosure.

### DETAILED DESCRIPTION

Embodiments of this invention are not limited in their application to the details of construction and the arrangement of components set forth in the following description or illustrated in the drawings. Embodiments of the invention are capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

According to one aspect of the present invention, it is appreciated that tools that allow patients to manage their disease and health enable the patient to receive higher quality health care, improved access to health care support, lower health care costs, greater adherence to treatment, and a better quality of life. To this end, systems and methods are described herein that permit, among others, patients, their families, and health care professionals to more effectively manage diseases, especially chronic diseases (e.g., orphan diseases such as the diseases described herein).

According to at least one embodiment, an application program is provided that may be used by a patient having an orphan, or rare, disease to receive current information regarding their disease, schedule treatments, track progress towards a therapeutic goal, and communicate with support personnel, such as a case manager, in matters relating to their treatment. For example, an application for a mobile device may be provided that integrates one or more of the above features in a single package that is easily and readily accessible to patients having such mobile devices. The application may be used by, for example, patients, family members, caregivers, healthcare professionals (e.g., health care providers), and case managers who are involved in the treatment of the patient.

### Orphan Diseases

As used herein, a disease which afflicts less than 200,000 individuals in the United States, or less than 5 per 10,000 individuals in the European Union, is considered to be an orphan disease (also referred to herein as a rare disease).

The underlying cause of an orphan disease and/or one or more parameters that are commonly monitored during treatment of an orphan disease can be managed and/or monitored with systems and methods that include the technology described herein.

Examples of orphan diseases include hereditary angioedema, Gaucher disease, Hunter syndrome, Sanfilippo A syndrome, Globoid Cell Leukodystrophy (Krabbe), and Metachromatic Leukodystrophy.

### Lysosomal Storage Disorders

Lysosomal storage diseases (LSDs) are a group of over 40 rare inherited metabolic disorders that result from defects in lysosomal function. Lysosomal storage diseases result when a specific organelle in the body's cells, the lysosomal, malfunctions.

Lysosomal storage disorders share a common pathogenesis of a genetic defect in a specific lysosomal enzyme, receptor target, activator protein, membrane protein, or transporter, leading to accumulation of substrates in cell lysosomes.

The underlying cause of a lysosomal storage disorder and/or one or more symptoms (and/or one or more side effects, e.g., of a treatment) of a lysosomal storage disorder can be managed and/or monitored with a system that includes the technology described herein.

LSDs can be divided into sub-categories based on the type of enzymatic defect and/or stored substrate product. For example, the mucopolysaccharidoses (the “MPS” diseases) are grouped together because each results from an enzyme deficiency that causes accumulation of a particular glycosaminoglycan substrate.

For example, sub-categories include:

Defective metabolism of glycosaminoglycans (also known as the “mucopolysaccharidoses”): Disorders in this sub-category include: MPS I, MPS II, MPS III, MPS IV, MPS VI and MPS VII.

Defective degradation of glycan portion of glycoproteins: Disorders in this sub-category include: aspartylglucosaminuria, fucosidosis type I, fucosidosis type II, mannosidosis, sialidosis type I and sialidosis type II.

Defective degradation of glycogen: Disorders in this sub-category include: Pompe disease.

Defective degradation of sphingolipid components: Disorders in this sub-category include: acid sphingomyelinase deficiency, Fabry disease, Farber disease, Gaucher disease type I, Gaucher disease type II, Gaucher disease type III, GM1 gangliosidosis type I, GM1 gangliosidosis type II, GM1 gangliosidosis type III, Tay-Sachs disease type I, Tay-Sachs disease type II, Tay-Sachs disease type III, Sandhoff disease, Krabbé disease, metachromatic leukodystrophy type I, metachromatic leukodystrophy type II and metachromatic leukodystrophy type III.

Defective degradation of polypeptides: Disorders in this sub-category include: pycnodysostosis.

Defective degradation or transport of cholesterol, cholesterol esters, or other complex lipids: Disorders in this sub-category include: neuronal ceroid lipofuscinosis type I, neuronal ceroid lipofuscinosis type II, neuronal ceroid lipofuscinosis type III and neuronal ceroid lipofuscinosis type IV.

Multiple deficiencies of lysosomal enzymes: Disorders in this sub-category include: galactosialidosis, mucolipidosis II and mucolipidosis III.

Transport and trafficking defects: Disorders in this sub-category include: cystinosis, mucolipidosis IV, infantile sialic acid storage disease (ISSD) and Salla disease.

The underlying cause of any of these subcategories of lysosomal storage disorders and/or one or more parameters that are commonly monitored using treatment of any of these subcategories of lysosomal storage disorders can be managed and monitored with systems and methods that include the technology described herein.

Parameters and treatments for representative lysosomal storage disorders that can be managed and/or monitored with systems and methods described herein are as follows.

### Gaucher's Disease

Gaucher's disease is a genetic disease in which a fatty substance or lipid accumulates in cells and certain organs. It can be caused by a hereditary deficiency (a to recessive mutation in the lysosomal glucocerebrosidase gene located on chromosome 1q21) of the enzyme glucocerebrosidase (also known as acid β-glucosidase), which acts on a fatty substance glucocerebroside (also known as glucosylceramide). When glucocerebrosidase is defective, the fatty substance accumulates, particularly in cells of the mononuclear cell lineage. Fatty material can collect in the spleen, liver, kidneys, lungs, brain and bone marrow. Different mutations in the glucocerebrosidase determine the remaining activity of the enzyme and to a large extent the phenotype. Heterozygotes for particular glucocerebrosidase mutations may be a risk-factor for Parkinson's disease and some malignancies (e.g., non-Hodgkin lymphoma, melanoma and pancreatic cancer).

Symptoms of Gaucher's disease include, e.g., decreased glucocerebrosidase enzyme activity, biochemical abnormalities (e.g., elevated level of one or more lysosomal enzymes (e.g., tartrate-resistant acid phosphatase, hexosaminidase, and chitinase (e.g., chitotriosidase)), high alkaline phosphatase, angiotensin-converting enzyme (ACE), and immunoglobulin levels), cellular abnormalities (e.g., “crinkled paper” cytoplasm and glycolipid-laden macrophages), enlarged spleen (splenomegaly), enlarged liver (hepatomegaly), hypersplenism, low platelet count, low hemoglobin level, anemia, neutropenia, thrombocytopenia, leucopenia, liver malfunction (e.g., cirrhosis), skeletal disorders (e.g., bone crisis), bone lesions, osteoporosis (e.g., deformity of the distal femur in the shape of an Erlenmeyer flask or aseptic necrosis of the femur joint), neurological symptoms or neurologic complications (e.g., convulsions, hypertonia, mental retardation, apnea, muscle twitches (e.g., myoclonus), dementia and ocular muscle apraxia), swelling of lymph nodes, swelling of adjacent joints, distended abdomen, yellowish-brown pigmentation or tint to the skin, and yellow fatty deposits on the white of the eye (sclera), and susceptibility to infection.

One or more symptoms described herein for Gaucher's disease (e.g., enlarged spleen, enlarged liver, low platelet count, bone crisis and pain, low hemoglobin level, biochemical abnormalities (e.g., elevated level of one or more lysosomal enzymes (e.g., tartrate-resistant acid phosphatase, hexosaminidase, and chitinase (e.g., chitotriosidase)), high alkaline phosphatase, angiotensin-converting enzyme (ACE), and immunoglobulin levels), cellular abnormalities (e.g., “crinkled paper” cytoplasm and glycolipid-laden macrophages)) may be a parameter that is recorded in a tracking feature of systems and methods described herein. For example, one or more of, e.g., enlarged spleen, enlarged liver, low platelet count, bone crisis and pain, and low hemoglobin level, can be evaluated, for example, by a health care provider. The evaluation may include one or more medical exams or tests, e.g., blood test, urine test, enzyme assay, bone marrow aspiration, biopsy, cell analysis, and medical imaging (e.g., MRI, CT, X-rays, and ultrasound). A parameter value can then be recorded by the tracking feature.

There are three common clinical subtypes (type I, type II and type III) for Gaucher's disease.

Type I (or non-neuropathic type) is the most common form of the disease, occurring in approximately 1 in 50,000 live births. Symptoms for type I Gaucher's disease may begin early in life or in adulthood and include enlarged liver and enlarged spleen (together hepatosplenomegaly). The enlarged spleen can rupture and cause additional complications. Skeletal weakness and bone disease may be extensive. Spleen enlargement and bone marrow replacement may cause anemia, thrombocytopenia and leukopenia. The brain is usually not affected, but there may be lung and kidney impairment.

Type II (or acute infantile neuropathic type) Gaucher's disease typically begins within 6 months of birth and has an incidence rate of approximately 1 in 100,000 live births. Symptoms for type II Gaucher's disease may include, e.g., enlarged liver and spleen, extensive and progressive brain damage, eye movement disorders, spasticity, seizures, limb rigidity, and a poor ability to suck and swallow.

Type III (or chronic neuropathic type) Gaucher's disease can begin at any time in childhood or even in adulthood, and occurs in approximately 1 in 100,000 live births. It is characterized by slowly progressive but milder neurologic symptoms compared to the acute or type II Gaucher's disease. Symptoms for type III Gaucher's disease may include, e.g., enlarged spleen and liver, seizures, poor coordination, skeletal irregularities, eye movement disorders, blood disorders including anemia and respiratory problems.

Treatment for Gaucher's disease includes, e.g., enzyme replacement treatment with recombinant glucocerebrosidase (e.g., imiglucerase (CEREZYME®) and velaglucerase alfa (VPRIV™)), glucosylceramide synthase inhibitors (e.g., miglustat (ZAVESCA®), Genz112638), isofagomine tartrate (AT-2101, HGT-34100, PLICERA™), bone marrow transplantation, surgery to remove the spleen (splenectomy), blood transfusion, joint replacement surgery to improve mobility and quality of life, antibiotics for infections, antiepileptics for seizures, bisphosphonates for bone lesions, liver transplants, substrate reduction therapy, and gene therapy.

Administration of the treatments described above, and/or information regarding the treatments described above, may be managed with systems and methods described herein.

### Fabry Disease

Fabry disease (also known as Fabry's disease, Anderson-Fabry disease, angiokeratoma corporis diffusum and alpha-galactosidase A deficiency) is a X-linked recessive lysosomal storage disease. A deficiency of the enzyme alpha-galactosidase A (a-GAL A, encoded by GLA) due to mutation causes a glycolipid known as globotriaosylceramide (Gb3, GL-3, or ceramide trihexoside) to accumulate within the blood vessels, other tissues, and organs, leading to an impairment of their proper function.

Symptoms of Fabry disease include, e.g., decreased alpha-galactosidase activity, renal involvement (e.g., proteinuria, renal insufficiency and renal failure), cardiac manifestations (e.g., hypertension and cardiomyopathy), dermatological manifestations (e.g., angiokeratomas, anhidrosis (lack of sweating), hyperhidrosis (excessive sweating), and Raynaud's disease-like symptoms with neuropathy (e.g., burning extremity pain)), ocular manifestations (e.g., cosmetic ocular involvement (e.g., cornea verticillata (vortex keratopathy), conjunctival aneurysms, posterior spoke-like cataracts, papilloedema, macular edema, optic atrophy and retinal vascular dilation), fatigue, neuropathy (e.g., burning extremity pain), increased risk of stroke due to cerebrovascular effects, tinnitus (ringing in the ears), vertigo, nausea, inability to gain weight, and diarrhea. One or more symptoms of Fabry disease (e.g., decreased level of alpha-galactosidase activity, proteinuria) may be a parameter that is evaluated and/or recorded in a tracking feature of systems and methods described herein. The evaluation may include one or more medical exams or tests, e.g., blood test, urine test, enzyme assay, and kidney biopsy.

Treatment for Fabry disease includes, e.g., enzyme replacement therapy (e.g., agalsidase alpha (REPLAGAL®) and agalsidase beta (FABRAZYME®), anticonvulsants (e.g., phenytoin and carbamazepine) for the pain the hands and feet, and metoclopramide for gastrointestinal hyperactivity), dialysis, and kidney transplantation.

Administration of the treatments described above, and/or information regarding the treatments described above, may be managed with systems and methods described herein.

### Pompe Disease/Glycogeg Storage Disease Type II

Pompe disease (also known as glycogen storage disease type II or acid maltase deficiency) is a neuromuscular, autosomal recessive metabolic disorder in the family of lysosomal storage diseases caused by a deficiency in the enzyme acid alpha-glucosidase (GAA), which acts on glycogen. The build-up of glycogen causes progressive muscle weakness (myopathy) throughout the body and affects various body tissues e.g., in the heart, skeletal muscles, liver and nervous system.

Pompe disease is characterized by decreased acid alpha-glucosidase enzyme activity. Symptoms for infantile or early onset Pompe disease include, e.g., lack of muscle tone, weakness, enlarged liver (hepatomegaly), enlarged heart (cardiomegaly), developmental defects, difficulty in swallowing, protruding and enlarged tongue, and respiratory or cardiac complications. Symptoms for juvenile onset Pompe disease include, e.g., progressive weakness of respiratory muscles (e.g., in the trunk, diaphragm and lower limbs) and exercise intolerance. Symptoms for adult onset Pompe disease include, e.g., generalized muscle weakness and wasting of respiratory muscles (e.g., in the trunk, lower limbs, and diaphragm), respiratory distress, headache at night or upon waking, diminished deep tendon reflexes, and proximal muscle weakness (e.g., difficulty in climbing stairs). Pompe's disease is one of the infiltrative causes of restrictive cardiomyopathy. One or more symptoms of Pompe disease (e.g., decrease acid alpha-glucosidase enzyme activity, enlarged liver, enlarged heart) may be a parameter that is evaluated and/or recorded in a tracking feature of systems and methods described herein. The evaluation may include one or more medical exams or tests, e.g., blood test, urine test, enzyme assay, and medical imaging (e.g., MRI, CT, X-rays, and ultrasound)).

Treatment for Pompe disease includes, e.g., enzyme replacement therapy (e.g., alglucosidase alfa (LUMIZYME™, MYOZYME®) and a glycosylation independent lysosomal targeting (GILT) tagged human acid alpha-glucosidase (GAA) (see, e.g., U.S. Patent Application Publication No. 2009/0117091).

Administration of the treatments described above, and/or information regarding the treatments described above, may be managed with systems and methods described herein.

### Hunter Syndrome

Hunter syndrome, or mucopolysaccharidosis Type II (MPS II), is a lysosomal storage disease and inherited disorder (X-linked recessive) caused by a deficient (or absent) enzyme, iduronate-2-sulfatase (I2S). It interferes with the body's ability to break down and recycle specific mucopolysaccharides (also known as glycosaminoglycans or GAG). GAG (e.g., dermatan sulfate and heparin sulfate) accumulation interferes with the way certain cells and organs in the body function and leads to a number of serious symptoms.

Symptoms for Hunter syndrome include, e.g., decreased iduronate sulfatase enzyme activity (e.g., in blood serum or cells), abdominal hernias, ear infections, runny noses, colds, a distinctive coarseness in their facial features (e.g., a prominent forehead, a nose with a flattened bridge, and an enlarged tongue, and enlarged abdomen), frequent infections of the ears and respiratory tract, thickening of the heart valves along with the walls of the heart, progressive decline in cardiac function, heart murmur, leaky heart valves, thickening of the walls of the airway, obstructive airway disease, pulmonary involvement, limited lung capacity, enlarged liver (hepatomegaly), enlarged spleen (splenomegaly), inguinal hernia, joint (e.g., finger, thumb, wrist, elbow, shoulder, hip and knee) stiffness and/or limited motion, spasticity, symptoms associate with carpal tunnel syndrome (CTS), short stature, pebbly, ivory-colored skin lesions (e.g., on the upper arms, legs and upper back), abnormal retina, delayed brain development, and mental retardation. One or more of the symptoms of Hunter syndrome (e.g., decreased iduronate sulfatase enzyme activity, enlarged spleen) may be a parameter that is evaluated and/or recorded in a tracking feature of systems and methods described herein. The evaluation may include one or more medical exams or tests, e.g., enzyme study (e.g., in serum, white blood cells, fibroblasts from skin biopsy, amniotic fluid, or chorionic villus tissue), blood test, urine test (e.g., for heparan sulfate and dermatan sulfate), enzyme assay, and medical imaging (e.g., MRI, CT, X-rays, and ultrasound).

Treatment for Hunter syndrome includes, e.g., enzyme replacement therapy (e.g., idursulfase (ELAPRASE®)), bone marrow graft, and palliative treatment.

Administration of the treatments described above, and/or information regarding the treatments described above, may be managed with systems and methods described herein.

### Schindler Disease

Schindler disease (also known as Kanzaki disease and Alpha-N-acetylgalactosaminidase deficiency) is an autosomal recessive disorder and lysosomal disease caused by a deficiency in the enzyme alpha-NAGA (alpha-N-acetylgalactosaminidase), attributable to mutations in the NAGA gene on chromosome 22 which leads to excessive lysosomal accumulation of glycoproteins. A deficiency of the alpha-NAGA enzyme leads to an accumulation of glycosphingolipids throughout the body. This accumulation of sugars gives rise to the clinical features associated with this disorder.

Schindler disease is characterized by decreased activity of alpha-NAGA. There are three main types (types I, II and III) of this disease. Symptoms for type I (infantile form) Schindler disease include, e.g., losing previously acquired skills involving the coordination of physical and mental behaviors, neurological and neuromuscular symptoms (e.g., diminished muscle tone, weakness, involuntary rapid eye movements, vision loss, and seizures), decreased ability to respond to external stimuli, neuroaxonal dystrophy from birth, discoloration of skin, telangiectasia (widening of blood vessels). Symptoms for type II (adult form) Schindler disease include, e.g., angiokeratomas (increased coarsening of facial features), and mild intellectual impairment. Symptoms for type III Schindler disease include, e.g., seizures, mental retardation, delayed speech, a mild autistic like presentation and/or behavioral problems. One or more symptoms of Schindler disease (e.g., decreased alpha-NAGA enzyme activity) may be a parameter that is evaluated and/or recorded in a tracking feature of systems and methods described herein. The evaluation may include one or more medical exams or tests, e.g., amniocentesis or chorionic villus sampling, urine test, blood test, enzyme assay, and skin biopsy.

Treatment for Schindler disease includes, e.g., enzyme replacement therapy, bone marrow transplants, and palliative treatment.

Administration of the treatments described above, and/or information regarding the treatments described above, may be managed with systems and methods described herein.

### Niemann-Pick Disease

Niemann-Pick disease refers to a group of fatal inherited metabolic disorders that are classified in a subgroup of lysosomal storage disorders (LSDs) called sphingolipidoses or lipid storage disorders in which harmful quantities of fatty substances, or lipids, accumulate in the spleen, liver, lungs, bone marrow, and brain. In the classic infantile type A variant, a missense mutation causes complete deficiency of acid sphingomyelinase (ASM). Sphingomyelin is a component of cell membrane including the organellar membrane and the enzyme deficiency blocks degradation of the lipid, resulting in the accumulation of sphingomyelin within lysosomes in the macrophage-monocyte phagocyte lineage. Affected cells become enlarged, sometimes up to 90 microns in diameter, secondary to the distention of lysosomes with sphingomyelin and cholesterol. Histology demonstrates lipid laden macrophages in the marrow, as well as “sea-blue histiocytes” on pathology. Numerous small vacuoles of relatively uniform size are created, imparting a foamy appearance to the cytoplasm. Niemann-Pick disease is classified as type A (classic infantile), type B (visceral), type C (subacute/juvenile) and type D (Nova Scotian).

Symptoms for Niemann-Pick disease include, e.g., decreased ASM enzyme activity, enlargement of the liver and spleen (hepatosplenomegaly), reduced appetite, abdominal distension and pain, thrombocytopenia, unsteady gait (ataxia), slurring of speech (dysarthria) and discoordinated swallowing (dysphagia), abnormal posturing of the limbs, trunk and face (dystonia), impaired voluntary rapid eye movements (supranuclear gaze palsy), dementia and seizures, gelastic cataplexy (sudden loss of muscle tone associated with laughter), and sleep inversion (sleepiness during the day and wakefulness at night). One or more symptoms of Niemann-Pick disease (e.g., decreased ASM enzyme activity, enlarged liver, and enlarged spleen) may be a parameter that is evaluated and/or recorded in a tracking feature of systems and methods described herein. The evaluation may include one or more medical exams or tests, e.g., sphingomyelinase assay (measuring the amount of ASM in white blood cells (e.g., using a blood or bone marrow sample)), skin biopsy (e.g., testing how the skin cells grow and how they move and store cholesterol), slit-lamp eye exam, liver biopsy, blood test, urine test, enzyme assay, bone marrow aspiration, and medical imaging (e.g., MRI, CT, X-rays, and ultrasound).

Treatment for Niemann-Pick disease includes, e.g., glucosylceramide synthase inhibitors (e.g., miglustat (ZAVESCA®), CYCLO (2-hydroxypropyl-β-cyclodextrin or HPBCD), organ transplant, bone marrow transplant, enzyme replacement therapy, gene therapy, and supportive care through nutrition, medication, physical therapy.

Administration of the treatments described above, and/or information regarding the treatments described above, may be managed with systems and methods described herein.

### Morquio Syndrome

Morquio's syndrome (referred to as mucopolysaccharidosis IV or Morquio's) is an autosomal recessive mucopolysaccharide or lysosomal storage disease. It is a rare type of dwarfism with serious consequences. When the body cannot process certain types of mucopolysaccharides, they build up or are eliminated, causing various symptoms. It involves accumulation of keratan sulfate. There are two forms of Morquio's syndrome, type A and type B. Type A is a deficiency of the enzyme N-acetylgalactosamine-6-sulfate sulfatase. Type B is a deficiency of the enzyme beta-galactosidase.

Symptoms for Morquio's syndrome include, e.g., decreased N-acetylgalactosamine-6-sulfate sulfatase activity, decreased beta-galactosidase activity, extra mucopolysaccharides, abnormal heart development, abnormal skeletal development, abnormal curvature of the spine (kyphoscoliosis), short statute (especially short trunk), hyper mobile joints, large fingers, knock-knees, widely spaced teeth, bell shaped chest (ribs flared), compression of spinal cord, enlarged heart, enlarged liver, heart murmur (aortic regurgitation), cloudy cornea, inguinal hernia, loss of nerve function below the neck, dwarfism, heart failure, difficulty with vision, walking problems, difficulty breathing. One or more symptoms of Morquio's syndrome (e.g., decreased N-acetylgalactosamine-6-sulfate sulfatase activity, decreased beta-galactosidase activity, enlarged heart, enlarged liver) may be a parameter that is evaluated and/or recorded in a tracking feature of systems and methods described herein. The evaluation may include one or more medical exams or tests, e.g., urine test (e.g., showing extra mucopolysaccharides), blood test, enzyme assay, echocardiogram, hearing test, slit-lamp eye exam, skin fibroblast culture, medical imaging (e.g., X-rays (e.g., of the long bone, ribs, and spine, MRI (e.g., of the lower skull and upper neck), CT, and ultrasound).

Treatment for Morquio syndrome includes, e.g., spinal fusion (e.g., to prevent irreversible spinal cord injury) and enzyme replacement therapy (e.g., MorCAP (a clinical assessment program by BioMarin)).

Administration of the treatments described above, and/or information regarding the treatments described above, may be managed with systems and methods described herein.

### Activator Deficiency/GM2 Gangliosidosis

GM2 gangliosidosis, activator deficiency (also called Tay-Sachs AB variant) is a rare, autosomal recessive (mutation in GM2A gene on chromosome 5) metabolic disorder that causes progressive destruction of nerve cells in the brain and spinal cord. It has a similar pathology to Sandhoff disease and Tay-Sachs disease. The three diseases are classified together as the GM2 gangliosidoses, because each disease represents a distinct molecular point of failure in the activation of the same enzyme, beta-hexosaminidase. AB variant is caused by a failure in the gene that makes an enzyme cofactor for beta-hexosaminidase, called the GM2 activator. This protein is required for the normal function of beta-hexosaminidase A, which breaks down GM2 ganglioside in the nervous system. If mutations in both alleles of the GM2A gene disrupt the activity of the GM2 activator, beta-hexosaminidase A cannot perform its normal function. As a result, gangliosides accumulate in the central nervous system until they interfere with normal biological processes. Progressive damage caused by buildup of gangliosides leads to the destruction of nerve cells.

Symptoms of GM2-gangliosidosis, AB variant include, e.g., decreased GM2 activator activity, delayed development, weakened muscle, loss of moving motor skills (such as turning over, sitting and crawling), seizure, vision loss, hearing loss, mental retardation, paralysis, ophthalmological abnormalities (e.g., cherry-red spot). One or more symptoms of GM2-gangliosidosis, AB variant (e.g., decreased GM2 activator activity, vision loss, hearing loss) may be a parameter that is evaluated and/or recorded in a tracking feature of systems and methods described herein. The evaluation may include one or more medical exams or tests, e.g., blood test, urine test, enzyme assay, vision test, hearing test.

Treatment for GM2-gangliosidosis, AB variant includes, e.g., palliative treatment and enzyme replacement therapy.

Administration of the treatments described above, and/or information regarding the treatments described above, may be managed with systems and methods described herein.

### Alpha-Mannosidosis

Alpha-mannosidosis is a lysosomal storage disorder caused by deficient activity of the enzyme alpha-D-mannosidase, caused by an autosomal recessive genetic mutation. A defective α-mannosidase enzyme, which normally helps to break down complex sugars derived from glycoproteins in the lysosome, causes sugar build up and impairs cell function. Alpha-mannosidosis is classified into types I through III based on severity and age of onset.

Symptoms of alpha-mannosidosis include, e.g., mental retardation, liver enlargement (hepatomegaly), spleen enlargement (splenomegaly), hearing loss, respiratory infections, skeletal abnormalities, facial features (e.g., protruding forehead, leveled nasal bridge, small nose, wide mouth), muscular weakness, and spinal abnormalities. One of more of the symptoms of alpha-mannosidosis (e.g., decreased α-mannosidase activity, enlarged liver, enlarged spleen, hearing loss) may be a parameter that is evaluated and/or recorded in a tracking feature of systems and methods described herein. The evaluation may include one or more medical exams or tests, e.g., blood test, urine test, enzyme assay, hearing test, medical imaging (e.g., MRI, CT, X-rays, and ultrasound).

Treatment for alpha-mannosidosis includes, e.g., palliative treatment and enzyme replacement therapy.

Administration of the treatments described above, and/or information regarding the treatments described above, may be managed with systems and methods described herein.

### Aspartylglucosaminuria

Aspartylglucosaminuria (AGU), also called aspartylglycosaminuria, is a rare, autosomal recessive lysosomal storage disorder caused by deficient activity of the enzyme N-aspartyl-beta-glucosaminidase (aspartylglucosaminidase). This enzyme normally cleaves long sugar chains known as oligosaccharides in the lysosome. When N-aspartyl-beta-glucosaminidase is deficient these long sugar chains build up and eventually lead to the clinical features of aspartylglucosaminuria. Aspartylglucosaminuria is one of the glycoprotein storage diseases.

Symptoms of aspartylglucosaminuria include, e.g., high urinary level of aspartylglucosamine, increased concentration of oligosaccharides in urine, low activity of aspartylglucosaminidase, psychomotor retardation, seizure, grotesque facial appearance, hepatosplenomegaly, ventral hernia and skeletal abnormalities. One or more of the symptoms of aspartylglucosaminuria (e.g., high levels of aspartylglucosamine, increased concentration of oligosaccharides, and low activity of aspartylglucosaminidase) may be a parameter that is evaluated and/or recorded in a tracking feature of systems and methods described herein. The evaluation may include one or more medical exams or tests, e.g., blood test, urine test, enzyme assay, and biopsy.

Treatment for aspartylglucosaminuria includes, e.g., palliative treatment and enzyme replacement therapy.

Administration of the treatments described above, and/or information regarding the treatments described above, may be managed with systems and methods described herein.

### Cholesteryl Ester Storage Disease

Cholesteryl ester storage disease is a rare autosomal recessive lysosomal storage disease that results from storage of cholesteryl esters and triglycerides in cells in the blood and lymph and lymphoid tissue. This build up occurs because lysosomal acid lipase, the essential enzyme to break down triglycerides and cholesteryl esters in lysosomes, is deficient. Although there is a build up of both triglycerides and cholesteryl esters in cholesteryl ester storage disease, there is a greater accumulation of cholesteryl esters than triglycerides.

Symptoms of cholesteryl ester storage disease include, e.g., decreased lysosomal acid lipase activity, enlarged liver (hepatomegaly), cirrhosis, chronic liver failure, atherosclerosis, hardening of the arteries, calcium deposits in the adrenal glands, jaundice, elevated levels of serum Low Density Lipoprotein (LDL). One or more symptoms of cholesteryl ester storage disease (e.g., decreased lysosomal acid lipase activity, enlarged liver, elevated levels of serum LDL) may be a parameter that is evaluated and/or recorded in a tracking feature of systems and methods described herein. The evaluation may include one or more medical exams or tests, e.g., blood test, urine test, enzyme assay (e.g., in liver cells, cultured blood cells or tissue specimens), medical imaging (e.g., MRI, CT, X-rays, and ultrasound).

Treatment for cholesteryl ester storage disease includes, e.g., palliative treatment (e.g., combining drugs that reduce blood cholesterol with a low cholesterol diet) and enzyme replacement therapy.

Administration of the treatments described above, and/or information regarding the treatments described above, may be managed with systems and methods described herein.

### Chronic Hexosaminidase A Deficiency

Chronic hexosaminidase A deficiency (also known as late onset Tay-Sachs disease) is an autosomal recessive disorder caused by the deficiency of hexosaminidase A (Hex-A). Without Hex-A, a fatty substance or lipid called GM2 ganglioside accumulates abnormally in cells, especially in the nerve cells of the brain. Gangliosides need to be biodegraded rapidly in early life, as the brain develops. This ongoing accumulation causes progressive damage to the cells. It is similar to Tay-Sachs disease, but develops much later and at a slower pace. People with the late-onset condition have a small residual amount of Hex-A rather than a complete absence of the enzyme.

Symptoms of chronic hexosaminidase A deficiency include, e.g., progressive dystonia, spinocerebellar degeneration, motor neuron disease, bipolar form of psychosis, progressive muscle wasting, weakness, muscle twitching, and poor articulation of words. One or more symptoms of chronic hexosaminidase A deficiency (e.g., decreased beta hexosaminidase A activity) may be a parameter that is evaluated and/or recorded in a tracking feature of systems and methods described herein. The evaluation may include, e.g., blood test, urine test, enzyme assay (e.g., in blood or tissue samples).

Treatment for chronic hexosaminidase A deficiency includes, e.g., conventional antipsychotic or antidepressant therapy, lithium salts, electroconvulsive therapy, and enzyme replacement therapy.

Administration of the treatments described above, and/or information regarding the treatments described above, may be managed with systems and methods described herein.

### Cystinosis

Cystinosis is a lysosomal storage disease characterized by the abnormal accumulation of the amino acid cystine due to mutations in the gene CTNS, located on chromosome 17, which codes for cystinosin, the lysosomal cystine transporter. Cystinosis is a common cause of Fanconi syndrome in the pediatric age group.

Symptoms of cystinosis include, e.g., accumulation of cystine within the cell, polyuria (excessive urination), dehydration, abnormally acidic blood (acidosis), poor growth, photophobia, kidney malfunction (e.g., renal Fanconi syndrome), kidney failure, soft and bowed bones (hypophosphatemic rickets), cystine crystals in the cornea, sensitivity to light (photophobia), muscle deterioration, blindness, inability to swallow, diabetes, and thyroid and nervous system problems. One or more symptoms of cystinosis (e.g., accumulation of cystine within the cell) may be a parameter that is evaluated and/or recorded in a tracking feature of systems and methods described herein. The evaluation may include one or more medical exams or tests, e.g., tandem mass spectrometry (e.g., to measure white blood cell cystine levels), blood test, and urine test.

Treatment for cystinosis includes, e.g., cysteamine (CYSTAGON®), sodium citrate (e.g., to treat blood acidosis), and potassium and phosphorus supplements.

Administration of the treatments described above, and/or information regarding the treatments described above, may be managed with systems and methods described herein.

### Danon Disease

Danon disease (or glycogen storage disease Type IIb) is a metabolic disorder caused by mutations in LAMP2 gene located on the X chromosome. The protein encoded by the LAMP2 gene is located on lysosomes.

Symptoms of Danon disease include, e.g., elevated creatine kinase (CPK) levels, muscle weakness, loss of motor skillsheart disease, heart muscle abnormalities, thickened and stiff heart (hypertrophic cardiomyopathy), enlarged heart (dilated cardiomyopathy), shortness of breath, fatigue, fluid gain, conduction abnormalities (Wolff-Parkinson-White syndrome), learning problems or mental retardation, and vision abnormalities (e.g., pigment in retinas). One or more of the symptoms (e.g., elevated CPK levels, cardiomyopathy) may be a parameter that is evaluated and/or recorded in a tracking feature of systems and methods described herein. The evaluation may include, e.g., blood test, urine test, enzyme assay (e.g., to measure CPK levels in blood), electrocardiogram (ECG), eye examination, and medical imaging (e.g., MRI, CT, X-rays, and ultrasound (e.g., echocardiogram)).

Treatment for Danon disease includes, e.g., physical therapy and palliative treatment.

Administration of the treatments described above, and/or information regarding the treatments described above, may be managed with systems and methods described herein.

### Farber Disease

Farber disease (also known as Farber's lipogranulomatosis, ceramidase deficiency, Fibrocytic dysmucopolysaccharidosis, and Lipogranulomatosis) is a rare autosomal recessive lysosomal storage disease that cause an accumulation of fatty material lipids leading to abnormalities in the joints, liver, throat, tissues and central nervous system. Normally, the enzyme ceramidase breaks down fatty material in the body's cells. In Farber Disease, the gene responsible for making this enzyme is mutated. Hence, the fatty material accumulates in various parts of the body, leading to the signs and symptoms of this disorder. It is associated with a deficiency in the ASAH1 gene.

Symptoms of Farber disease include, e.g., decreased ceramidase activity, impaired mental ability, difficulty in swallowing, difficulty in breathing, enlarged liver (hepatomegaly), enlarged spleen (splenomegaly), heart impairment, kidney impairment, vomiting, arthritis, swollen lymph nodes, swollen joints, joint contractures (chronic shortening of muscles or tendons around joints), hoarseness, granulomas, and xanthomas. One or more symptoms of Farber disease (e.g., decreased ceramidase activity, enlarged liver, enlarged spleen) may be a parameter that is evaluated and/or recorded in a tracking feature of systems and methods described herein. The evaluation may include one or more medical exams and tests, e.g., blood test, urine test, enzyme assay, and medical imaging (e.g., MRI, CT, X-rays, and ultrasound).

Treatment for Farber disease includes, e.g., enzyme replacement therapy, corticosteroids (e.g., to relieve pain), bone marrow transplant, surgery (e.g., to remove or reduce granulomas).

Administration of the treatments described above, and/or information regarding the treatments described above, may be managed with systems and methods described herein.

### Fucosidosis

Fucosidosis (also known as alpha-1-fucosidase deficiency) is a rare autosomal recessive lysosomal storage disease in which the enzyme fucosidase is not properly used in the cells to break down fucose. This enzyme normally cleaves long sugar chains known as oligosaccharides in the lysosome. When the enzyme is deficient, sugar chains accumulate and eventually lead to the clinical features of fucosidosis. Focosidosis is one of the glycoprotein storage diseases. The gene encoding the alpha-fucosidase, FUCA1, is located to the short arm of chromosome 1. There are two different types of fucosidosis, Type I and Type II, characterized by the age of onset and by the types of physical and mental manifestations of the disorder.

Symptoms of type I fucosidosis include, e.g., decreased fucosidase activity, coarsening of facial features, enlarged liver (hepatomegaly), enlarged spleen (splenomegaly), enlarged heart, abnormal bone deformities, cherry red spots on the surface of the eye, mental retardation, seizure, psychomotor regression, severe and rapidly progressing neurologic signs, and elevated sodium and chloride excretion in the sweat. Symptoms of type II fucosidosis include, e.g., decreased fucosidase activity, angiokeratoma, milder psychomotor retardation and neurologic signs, mild coarsening of facial features, abnormal bone deformities, mental retardation, enlarged liver, enlarged spleen, enlarged heart, and twisted blood vessels (e.g., within the membrane covering of the eye and inner eyelid). One or more symptoms of fucosidosis (e.g., decreased fucosidase activity, enlarged liver, enlarged spleen) may be a parameter that is evaluated and/or recorded in a tracking feature of systems and methods described herein. The evaluation may include one or more medical exams or tests, e.g., blood test, urine test, enzyme assay, biopsy, and medical imaging (e.g., MRI, CT, X-rays, and ultrasound).

Treatment for fucosidosis includes, e.g., enzyme replacement therapy, bone marrow transplant, and palliative treatment.

Administration of the treatments described above, and/or information regarding the treatments described above, may be managed with systems and methods described herein.

### Galactosialidosis

Galactosialidosis is a rare lysosomal storage disease characterized by the deficiency in cathepsin A due to mutations in the CTSA gene. Cathepsin A functions together with neuraminidase 1 and beta-galactosidase to form a protein complex, which breaks down sugar molecules (oligosaccharides) attached to glycoproteins or glycolipids. Cathepsin A also forms a complex on the cell surface with neuraminidase 1 and elastin binding protein. Elastin binding protein plays a role in the formation of elastic fibers, a component of the connective tissues that form the body's supportive framework. CTSA mutations interfere with the normal function of cathepsin A. Most mutations disrupt the protein structure of cathepsin A, impairing its ability to form complexes with neuraminidase 1, beta-galactosidase, and elastin binding protein. As a result, these other enzymes are not functional, or they break down prematurely.

There are three forms of galactosialidosis which are distinguished by the age at which symptoms develop and the pattern of features. Symptoms of the early infantile form of galactosialidosis include, e.g., increased oligosaccharides, decreased beta-galactosidase levels, decreased neuraminidase levels, extensive swelling (e.g., caused by fluid accumulation before birth (hydrops fetalis)), soft outpouching in the lower abdomen (an inguinal hernia), enlarged liver (heptomegaly), enlarged spleen (hepatosplenomegaly), abnormal bone development (dysostosis multiplex), distinctive facial features (e.g., coarse), enlarged heart (cardiomegaly), eye abnormality (e.g., cherry-red spot), kidney disease, and kidney failure. Symptoms of the late infantile form of galactosialidosis include, e.g., increased oligosaccharides, decreased beta-galactosidase levels, decreased neuraminidase levels, short stature, dysostosis multiplex, heart valve problems, hepatosplenomegaly, coarse facial features, intellectual disability, hearing loss, eye abnormality (e.g., a cherry-red spot). Symptoms of the juvenile/adult form of galactosialidosis include, e.g., increased oligosaccharides, decreased beta-galactosidase levels, decreased neuraminidase levels, difficulty coordinating movements (ataxia), muscle twitches (myoclonus), seizures, progressive intellectual disability, dark red spots on the skin (angiokeratomas), abnormalities in the bones of the spine, coarse facial features, eye abnormality (e.g., a cherry-red spot), vision loss, and hearing loss. One or more symptoms of galactosialidosis (e.g., increased oligosaccharides, decreased beta-galactosidase levels, decreased neuraminidase levels, enlarged liver, enlarged spleen) may be a parameter that is evaluated and/or recorded in a tracking feature of systems and methods described herein. The evaluation may include one or more medical exams or tests, e.g., blood test, urine test, biopsy, enzyme assay, chorionic villus sampling (CVS), amniocentesis, eye examination, and medical imaging (e.g., MRI, CT, X-rays, and ultrasound).

Treatment for galactosialidosis includes, e.g., enzyme replacement therapy, bone marrow transplant, and palliative treatment.

Administration of the treatments described above, and/or information regarding the treatments described above, may be managed with systems and methods described herein.

### GM1 Gangliosidosis

GM1 gangliosidosis is an autosomal recessive lysosomal storage disorder characterized by the generalized accumulation of GM1 ganglioside, oligosaccharides, and the mucopolysaccharide keratan sulfate (and their derivatives). In GM1 gangliosidosis, deficiency of the lysosomal hydrolase, acid beta-galactosidase results in the accumulation of glycoconjugates in body tissues and their excretion in urine. GM1 ganglioside and its derivative asialo-GM1 ganglioside (GA1), glycoprotein-derived oligosaccharides, and keratan sulfate are found at elevated intracellularconcentrations. Accumulation of toxic asialo-compound and lyso-compound GM1 ganglioside derivatives is believed to be neuropathic.

There are three clinical subtypes of GM1 gangliosidosis (early infantile, late infantile/juvenile, and adult/chronic. Symptoms of early infantile GM1 gangliosidosis include, e.g., decreased acid beta-galactosidase activity, galactose-containing oligosaccharides in the urine, vacuolation of lymphocytes, dried blood spots, neurodegeneration, seizures, enlarged liver (hepatomegaly), enlarged spleen (splenomegaly), coarsening of facial features, skeletal irregularities, joint stiffness, distended abdomen, muscle weakness, exaggerated startle response to sound, cherry-red spots in the eye, cardiac complications, pneumonia, and problems with gait. Symptoms of late infantile/juvenile GM1 gangliosidosis include, e.g., decreased acid beta-galactosidase activity, galactose-containing oligosaccharides in the urine, vacuolation of lymphocytes, ataxia, seizures, dementia, and difficulties with speech. Symptoms of adult/chronic GM1 gangliosidosis include, e.g., decreased acid beta-galactosidase activity, galactose-containing oligosaccharides in the urine, vacuolation of lymphocytes, muscle atrophy, neurological complications, corneal clouding, and dystonia (sustained muscle contractions that cause twisting and repetitive movements or abnormal postures), angiokeratomas (e.g., on the lower part of the trunk of the body). One or more symptoms of GM1 angliosidosis (e.g., decreased acid beta-galactosidase activity, galactose-containing oligosaccharides in the urine, vacuolation of lymphocytes) may be a parameter that is evaluated and/or recorded in a tracking feature of systems and methods described herein. The evaluation may include one or more medical exams or tests, e.g., blood test, urine test, enzyme assay (e.g., acid beta-galactosidase activity), complete blood count (CBC), electrocardiography, electroencephalography, and medical imaging (e.g., MRI, CT, X-rays, and ultrasound).

Treatment for GM1 gangliosidosis includes, e.g., enzyme replacement therapy, bone marrow transplantation, presymptomatic cord-blood hematopoietic stem-cell transplantation, symptomatic treatment, and gene therapy.

Administration of the treatments described above, and/or information regarding the treatments described above, may be managed with systems and methods described herein.

### I-Cell Disease/Mucolipidosis II

Inclusion-cell (I-cell) disease, also referred to as mucolipidosis II (ML II), is an autosomal recessive lysosomal storage disease and results from a defective GlcNAc phosphotransferase, which phosphorylates mannose residues to mannose-6-phosphate on N-linked glycoproteins in the Golgi apparatus within the cell. Without mannose-6-phosphate to target them to the lysosomes, the enzymes are transported from the Golgi to the extracellular space, resulting in large intracellular inclusions of molecules (inclusion bodies containing carbohydrates, lipids and proteins) requiring lysosomal degradation in patients with the disease. I-cell disease can be associated with the GNPTA gene.

Symptoms of I-cell disease include, e.g., decreased GlcNAc phosphotransferase activity, intracytoplasmic inclusions in cells of mesenchymal origin, developmental delays, abnormal skeletal development, coarse facial features, restricted joint movement, enlarged liver (hepatomegaly), enlarged spleen (splenomegaly), enlarged heart valves, stiff claw-shaped hands, delays in the development of motor skills, delays in development of cognitive (mental processing) skills, clouding on the cornea, short-trunk dwarfism, recurrent respiratory tract infections (e.g., pneumonia, otitis media (middle ear infections), bronchitis and carpal tunnel syndrome), and congestive heart failure. One or more symptoms of I-cell disease (e.g., decreased GlcNAc phosphotransferase activity, intracytoplasmic inclusions in cells of mesenchymal origin, enlarged liver, enlarged spleen) may be a parameter that is evaluated and/or recorded in a tracking feature of systems and methods described herein. The evaluation may include one or more medical exams or tests, e.g., blood test, urine test, enzyme assay (e.g., to measure GlcNAc phosphotransferase activity (e.g., in white blood cells or in cultured fibroblasts), or various lysosomal enzyme (e.g., beta-hexosaminidase, iduronate sulfatase, and/or arylsulfatase A) activities (e.g., in serum or in cultured fibroblasts), electron microscopy (e.g., to detect the presence of intracytoplasmic inclusions the cells of mesenchymal origin), and medical imaging (e.g., MRI, CT, X-rays, and ultrasound).

Treatment for I-cell disease includes, e.g., enzyme replacement therapy, bone marrow transplant, controlling or reducing the symptoms associated with this disorder, nutrition supplements (e.g., iron and vitamin B12), physical therapy, surgery (e.g., to remove the thin layer of corneal clouding to temporarily improve the complication).

Administration of the treatments described above, and/or information regarding the treatments described above, may be managed with systems and methods described herein.

### Infantile Free Sialic Acid Storage Disease (ISSD)

Infantile free sialic acid storage disease (ISSD) is a lysosomal storage disease caused by the deficiency in sialin due to mutations in the SLC17A5 (solute carrier family 17 (anion/sugar transporter), member 50) gene. In ISSD, sialic acid is unable to be transported out of the lysosomal membrane and instead, accumulates in the tissue and free sialic acid is excreted in the urine.

Symptoms of ISSD include, e.g., increased free sialic acid in the urine, developmental delay, weak muscle tone (hypotonia), failure to gain weight, failure to thrive, coarse facial features, seizures, bone malformations, enlarged liver (enlarged heptomegaly), enlarged spleen (splenomegaly), and enlarged heart (cardiomegaly). One or more symptoms of ISSD (e.g., increased free sialic acid in the urine, enlarged liver, enlarged spleen, and enlarged heart) may be a parameter that is evaluated and/or recorded in a tracking feature of systems and methods described herein. The evaluation may include one or more medical exams or tests, e.g., urine test, blood test, enzyme assay, biopsy, medical imaging (e.g., MRI, CT, X-rays, and ultrasound).

### Juvenile Hexosaminidase A Deficiency

Juvenile Hexosaminidase A Deficiency is an autosomal recessive lysosomal storage disease caused by the deficiency in hexosaminidase A (Hex-A) due to mutations in the HEXA gene. In Juvenile hexosaminidase A deficiency, GM2 ganglioside accumulates abnormally in cells, e.g., in the nerve cells of the brain. Gangliosides need to be biodegraded rapidly in early life as the brain develops. This ongoing accumulation causes progressive damage to the cells.

Symptoms for juvenile hexosaminidase A deficiency include, e.g., decreased hexoaminidase activity, ataxia, deteriorated speech and mental cognition, loss of vision, optic atrophy, retinitis pigmentosa. One or more symptoms of juvenile hexosaminidase A deficiency (e.g., decreased hexoaminidase activity) may be a parameter that is evaluated and/or recorded in a tracking feature of systems and methods described herein. The evaluation may include one or more medical exams or tests, e.g., blood test, urine test, enzyme assay, biopsy, eye examination, medical imaging (e.g., MRI, CT, X-rays, and ultrasound).

Treatment for juvenile hexosaminidase A deficiency includes, e.g., enzyme replacement therapy, anticonvulsant medicine, adequate nutrition and hydration, techniques to keep airway open, and gene therapy.

Administration of the treatments described above, and/or information regarding the treatments described above, may be managed with systems and methods described herein.

### Krabbe Disease

Krabbe disease (also known as globoid cell leukodystrophy or galactosylceramide lipidosis) is a rare, often fatal degenerative disorder that affects the myelin sheath of the nervous system. This condition is inherited in an autosomal recessive pattern. Krabbe disease is caused by mutations in the GALC gene, which causes a deficiency of galactocerebrosidase. The build up of unmetabolized lipids affects the growth of the nerve's protective myelin sheath (the covering that insulates many nerves) and causes severe degeneration of motor skills. As part of a group of disorders known as leukodystrophies, Krabbe disease results from the imperfect growth and development of myelin.

There are two subclinical types of Krabbe disease (infantile onset and late onset (juvenile/adult onset), which have similar symptoms but different rate of progression. Symptoms of Krabbe disease include, e.g., grouping of certain cells (multinucleated globoid cells), nerve demyelination, nerve degeneration, destruction of brain cells, irritability, fevers, limb stiffness, seizures, feeding difficulties, vomiting, slowing of mental and motor development, muscle weakness, spasticity, deafness, optic atrophy, blindness, paralysis, difficulty when swallowing, and prolonged weight loss. One or more symptoms of Krabbe disease (e.g., decreased galactocerebrosidase activity, nerve demyelination, nerve degeneration) may be a parameter that is evaluated and/or recorded in a tracking feature of systems and methods described herein. The evaluation may include one or more medical exams or tests, e.g., blood test, urine test, enzyme assay (e.g., to measure galactosylceramidase levels (e.g., in white blood cells)), cerebrospinal fluid (CSF) total protein, nerve conduction velocity, Luxol Fast Blue staining protocol for myelin, eye examination, and medical imaging (e.g., MRI (e.g., for head), CT, X-rays, and ultrasound).

Treatment for Krabbe disease includes, e.g., enzyme replacement therapy, bone marrow transplantation, physical therapy, and cord blood transplants.

Administration of the treatments described above, and/or information regarding the treatments described above, may be managed with systems and methods described herein.

### Metachromatic Leukodystrophy

Metachromatic leukodystrophy (MLD, also called Arylsulfatase A deficiency) is a lysosomal storage disease which is commonly listed in the family of leukodystrophies. Leukodystrophies affect the growth and/or development of myelin, the fatty covering which acts as an insulator around nerve fibers throughout the central and peripheral nervous systems. It involves sulfatide accumulation. MLD is directly caused by a deficiency of the enzyme arylsulfatase A. In MLD, sulfatides build up in many tissues of the body due to the deficiency of arylsulfatase A, eventually destroying the myelin sheath of the nervous system. Without myelin sheath, the nerves in the brain and the peripheral nerves which control, among other things the muscles related to mobility, cease to function properly.

There are three forms of MLD, which are late infantile, juvenile, and adult. Symptoms of the late infantile form of MLD include, e.g., decreased arylsulfatase A activity, accumulation of sulfatides, muscle wasting and weakness, muscle rigidity, developmental delays, progressive loss of vision, blindness, convulsions, impaired swallowing, paralysis, coma, abnormal white matter (leukodystrophy), atrophy of the brain, and dementia. Symptoms of the juvenile form of MLD include, e.g., decreased arylsulfatase A activity, accumulation of sulfatides, impaired school performance, mental deterioration, and dementia. The symptoms of the adult form of MLD include, e.g., decreased arylsulfatase A activity, accumulation of sulfatides, psychiatric disorder, and progressive dementia. One or more symptoms of MLD (e.g., decreased arylsulfatase A activity, accumulation of sulfatides, abnormal white matter (leukodystrophy), atrophy of the brain, psychological and cognitive abilities) may be a parameter that is evaluated and/or recorded in a tracking feature of systems and methods described herein. The evaluation may include one or more medical exams or tests, e.g., blood test, urine test, enzyme assay, nerve conduction study (electroneurograph), medical imaging (e.g., MRI, CT, X-rays, and ultrasound), psychological and cognitive test.

Treatment for MLD includes, e.g., enzyme replacement therapy (e.g., HGT-1111), bone marrow transplantation, stem cell transplantation, pain and symptom management, gene therapy, substrate reduction therapy, and enzyme enhancement therapy.

Administration of the treatments described above, and/or information regarding the treatments described above, may be managed with systems and methods described herein.

### Multiple Sulfatase Deficiency

Multiple sulfatase deficiency (or Austin's disease or mucosulfatidosis), is a rare autosomal recessive lysosomal storage disease caused by a deficiency in multiple sulfatase enzymes. An association of multiple sulfatase deficiency with SUMF1 has been described. Sulfatase enzymes are responsible for breaking down and recycling complex sulfate-containing sugars from lipids and mucopolysaccharides within the lysosome. The accumulation of lipids and mucopolysaccharides inside the lysosome results in symptoms associated with this disorder.

Symptoms of multiple sulfatase deficiency include, e.g., decreased sulfatase activity, accumulation of mucopolysaccharides and other sulfated complex sugars, coarsened facial features, deafness, ichthyosis, enlarged liver (heptomegaly) and spleen (splenomegaly), abnormalities of the skeleton (e.g., curving of the spine and breast bone), dry skin, and delayed development of speech and walking skills. One or more symptoms of multiple sulfatase deficiency (e.g., decreased sulfatase activity, accumulation of mucopolysaccharides, enlarged liver, enlarged spleen) may be a parameter that is evaluated and/or recorded in a tracking feature of systems and methods described herein. The evaluation may include one or more medical exams or tests, e.g., blood test (e.g., to measure sulfatase activity in white blood cells), urine test (e.g., to measure the level of mucopolysaccharides and other sulfated complex sugars), enzyme assay, and medical imaging (e.g., MRI, CT, X-rays, and ultrasound).

Treatment for multiple sulfatase deficiency includes, e.g., enzyme replacement therapy, physiotherapy, and hydrotherapy.

Administration of the treatments described above, and/or information regarding the treatments described above, may be managed with systems and methods described herein.

### Pycnodysostosis

Pycnodysostosis is a lysosomal storage disease of the bone caused by a mutation in the gene that encodes the enzyme cathepsin K, which is a cysteine protease in osteoclasts. This is an autosomal recessive osteochondrodysplasia maps to chromosome 1q21.

Symptoms of pycnodysostosis include, e.g., decreased cathepsin K activity, short stature, craniofacial abnormalities, delayed tooth eruption, aplasia of clavicle, scoliosis, brachydactyly, narrow ilia, osteosclerosis, increased bone density, hypoplasia of clavicle, osteomyelitis, spondylolysis, spondylolisthesis, wormian bones, wrinkly skin on fingers, grooves in nails, flat nails, irregular permanent teeth, partial anodontia, and tooth caries. One or more symptoms of pycnodysostosis (e.g., decreased cathepsin K activity) may be a parameter that is evaluated and/or recorded in a tracking feature of systems and methods described herein. The evaluation may include one or more medical exams or tests, e.g., blood test, urine test, enzyme assay, medical imaging (e.g., MRI, CT, X-rays, and ultrasound).

Treatment for pycnodysostosis includes, e.g., enzyme replacement therapy, growth hormones, and dental hygiene.

Administration of the treatments described above, and/or information regarding the treatments described above, may be managed with systems and methods described herein.

### Sandhoff Disease

Sandhoff disease (also known as Jatzkewitz-Pilz syndrome and Hexosaminidase A and B deficiency) is a rare autosomal recessive lysosomal storage disorder where the patient has the inability to create the beta-hexosaminidase A and beta-hexosaminidase B, which are enzymes that lead to a build-up of GM2 gangliosides in tissues of the body, due to mutations in the HEXB gene. This build-up is toxic at high levels, which leads to a progressive destruction of the central nervous system, damages the tissues and eventually leads to death.

There are three subsets of the disease based on when the patient shows symptoms: classic infantile, juvenile and adult late onset.

Symptoms of Sandhoff disease include, e.g., decreased beta-hexosaminidase activity, accumulation of GM2 gangliosides, motor weakness, startle reaction to sound, early blindness, progressive mental deterioration, progressive motor deterioration, frequent respiratory infections, macrocephaly, doll-like facial appearance, cherry-red spots in the back of the eyes, seizures, myoclonus, muscle weakness, muscle wasting, mental deterioration, motor deterioration, cerebellar ataxia, blindness, enlarged heart, enlarged liver, enlarged spleen, unusual eye movements, cherry-red macular spots, bony dysplasias, poor infant head control, pneumonia, bronchopneumonia, and large head. One or more symptoms of Sandhoff disease (e.g., decreased beta-hexosaminidase activity, accumulation of GM2 gangliosides, enlarged liver, enlarged spleen) may be a parameter that is evaluated and/or recorded in a tracking feature of systems and methods described herein. The evaluation may include one or more medical exams or tests, e.g., blood test, urine test, enzyme assay, and medical imaging (e.g., MRI, CT, X-rays, and ultrasound).

Treatment for Sandhoff disease includes, e.g., enzyme replacement therapy, N-butyldeoxynojirimycin, proper nutrition and hydration, maintenance of clear airways, anticonvulsants, and stem cell treatment.

Administration of the treatments described above, and/or information regarding the treatments described above, may be managed with systems and methods described herein.

### Salla Disease

Salla disease (also called sialic acid storage disease or Finnish type sialuria) is an autosomal recessive lysosomal storage disease characterized by early physical impairment and mental retardation. The disorder is caused by a mutation in chromosome 6 (a recessive genetic trait in the gene SLC17A5, the locus of which is 6q14-15). This gene codes for sialin, a lysosomal membrane protein that transports the charged sugar, N-acetylneuraminic acid (sialic acid), out of lysosomes. The mutation causes sialic acid to build up in the cells.

Symptoms of Salla disease include, e.g., elevated levels of free sialic acid, growth retardation, nystagmus, hypotonia, reduced muscle tone and strength, arrested or delayed myelination, cognitive impairment, exotrophia, thick calvaria, delayed motor development, delayed mental development, mental retardation, ataxia, spasticity, athetosis, delayed and impaired speech, seizures, and inability to walk. One or more symptoms of Salla disease (e.g., elevated levels of free sialic acid) may be a parameter that is evaluated and/or recorded in a tracking feature of systems and methods described herein. The evaluation may include one or more medical exams or tests, e.g., urine test, blood test, enzyme assay, medical imaging (e.g., MRI, CT, X-rays, and ultrasound).

Treatment for Salla disease includes, e.g., anti-convulsant medication, physical therapy, and speech therapy.

Administration of the treatments described above, and/or information regarding the treatments described above, may be managed with systems and methods described herein.

### Tay-Sachs/GM2 Gangliosidosis

Tay-Sachs disease (TSD, also known as GM2 gangliosidosis or Hexosaminidase A deficiency) is an autosomal recessive genetic disorder resulted from mutations on chromosome 15 in the HEXA gene encoding the alpha-subunit of the lysosomal enzyme beta-N-acetylhexosaminidase A. These mutations have included base pair insertions and deletions, splice site mutations, point mutations, and other more complex patterns. Each of these mutations alters the protein product, and thus inhibits the function of the enzyme in some manner Hexosaminidase A catalyzes the biodegradation of fatty acid derivatives known as gangliosides. When hexosaminidase A is no longer functioning properly, the lipids accumulate in the brain and interfere with normal biological processes. The disease occurs when harmful quantities of gangliosides accumulate in the nerve cells of the brain, eventually leading to the premature death of those cells.

Tay-Sachs disease is classified in variant forms (infantile, juvenile, and adult/late onset TSD), based on the time of onset of neurological symptoms. Symptoms of TSD include, e.g., decreased hexosaminidase activity, accumulation of gangliosides, “cherry-red” macula, enlarged liver (hepatomegaly), enlarged spleen (splenomegaly), convulsions, deterioration of mental and physical abilities, loss of vision, loss of hearing, muscle atrophy, paralysis, dysarthria, dysphagia, unsteadiness of gait (ataxia), spasticity, and psychiatric illness (e.g., schizophrenic-like psychosis). One or more symptoms of Tay-Sachs disease (e.g., decreased hexosaminidase activity, enlarged liver, enlarged spleen) may be a parameter that is evaluated and/or recorded in a tracking feature of systems and methods described herein. The evaluation may include one or more medical exams or tests, e.g., blood test (e.g., to measure hexosaminidase activity), urine test, enzyme assay, eye examination, medical imaging (e.g., MRI, CT, X-rays, and ultrasound).

Treatment for Tay-Sachs disease includes, e.g., enzyme replacement therapy, and palliative care.

Administration of the treatments described above, and/or information regarding the treatments described above, may be managed with systems and methods described herein.

### Wolman Disease

Wolman disease (also known as Wolman's disease, Wolman's syndrome, and acid lipase deficiency) is a rare autosomal recessive lysosomal storage disease due to mutations in the LIPA gene. The LIPA gene encodes lysosomal acid lipase, which processes lipids such as cholesteryl esters and triglycerides so they can be used by the body. Mutations in this gene lead to a shortage of lysosomal acid lipase and the accumulation of triglycerides, cholesteryl esters, and other kinds of fats within the cells and tissues of affected individuals. This accumulation as well as malnutrition caused by the body's inability to use lipids properly result in the signs and symptoms of Wolman disease.

Symptoms of Wolman disease include, e.g., decreased lysosomal acid lipase activity, accumulation of cholesteryl esters, accumulation of triglycerides, mental deterioration, enlarged liver (hepatomegaly), enlarged spleen (splenomegaly), intrabdominal adenopathy, distended abdomen, steatorrhea (excessive amounts of fats in the stools), jaundice, anemia, vomiting, enlarged adrenal glands, calcium deposits in the adrenal glands, enlarged, low-density mesenteric and retroperitoneal lymph nodes. One or more symptoms of Wolman disease (e.g., decreased lysosomal acid lipase activity, accumulation of cholesteryl esters, accumulation of triglycerides, enlarged liver, enlarged spleen, enlarged adrenal glands) may be a parameter that is evaluated and/or recorded in a tracking feature of systems and methods described herein. The evaluation may include one or more medical exams and tests, e.g., blood test, urine test, enzyme assay, and medical imaging (e.g., MRI, CT, X-rays, and ultrasound).

Treatment for Wolman disease includes, e.g., management of the symptoms, bone marrow transplantation, enzyme replace therapy, and hormone therapy.

Administration of the treatments described above, and/or information regarding the treatments described above, may be managed with systems and methods described herein.

### Mucopolysaccharidoses

Mucopolysaccharidoses are a group of lysosomal storage disorders caused by the absence or malfunctioning of lysosomal enzymes needed to break down molecules called glycosaminoglycans—long chains of sugar carbohydrates in each of the cells that help build bone, cartilage, tendons, corneas, skin and connective tissue. Glycosaminoglycans (formerly called mucopolysaccharides) are also found in the fluid that lubricates our joints.

People with a mucopolysaccharidosis disease either do not produce enough of one of the lysosomal enzymes required to break down these sugar chains into simpler molecules, or they produce enzymes that do not work properly. Over time, these glycosaminoglycans collect in the cells, blood and connective tissues. The result is permanent, progressive cellular damage which affects appearance, physical abilities, organ and system functioning, and, in most cases, mental development.

Symptoms of the mucopolysaccharidoses include, e.g., decreased lysosomal enzyme activity, excess mucopolysaccharides, neurological complications (e.g., damage to neurons, pain, and impaired motor function), mental retardation, developmental delay, behavioral problems, hearing loss (conductive or neurosensitive), communicating hydrocephalus, cloudy cornea, glaucoma, degeneration of the retina, coarse or rough facial features (including a flat nasal bridge, thick lips, and enlarged mouth and tongue), short stature with disproportionately short trunk (dwarfism), dysplasia (abnormal bone size and/or shape) and other skeletal irregularities, thickened skin, enlarged organs such as liver (hepatomegaly) or spleen (splenomegaly), hernias, and excessive body hair growth, short and often claw-like hands, progressive joint stiffness, and carpal tunnel syndrome, recurring respiratory infections, obstructive airway disease, obstructive sleep apnea, heart disease (e.g., enlarged or diseased heart valves). One or more symptoms of the mucopolysaccharidoses (e.g., decreased lysosomal enzyme activity, enlarged liver, enlarged spleen) may be a parameter that is evaluated and/or recorded in a tracking feature of systems and methods described herein. The evaluation may include one or more medical exams or tests, e.g., urine test (to measure excess mucopolysaccharides), enzyme assay (to test a variety of cells or body fluids in culture for enzyme deficiency), amniocentesis and chorionic villus sampling, blood test, and medical imaging (e.g., MRI, CT, X-rays, and ultrasound).

Treatments for mucopolysaccharidoses include, e.g., physical therapy, surgery (e.g., surgery to remove tonsils and adenoids to improve breathing, surgical insertion of an endotrachial tube to aid breathing, surgery to correct hernias, help drain excessive cerebrospinal fluid from the brain, and free nerves and nerve roots compressed by skeletal and other abnormalities), corneal transplants, enzyme replacement therapy (e.g., ELAPRASE® as a treatment for MPS type II (Hunter syndrome)), bone marrow transplantation (BMT), and umbilical cord blood transplantation (UCBT).

Administration of the treatments described above, and/or information regarding the treatments described above, may be managed with systems and methods described herein.

### Overview of Various Embodiments of the Disclosure

According to various embodiments, it is appreciated that techniques for planning, scheduling, and tracking the treatment of a chronic disease (e.g., an orphan disease such as a disease described herein), which are convenient and accessible to the patient, are desirable. According to one embodiment, it is appreciated that providing the patient with more information and control of their health care leads to an improved quality of life. For example, by using the techniques disclosed herein, the patient may be able to lead a more independent lifestyle, as well as be able to reduce the frequency of visits to a health care provider.

Empirical evidence suggests that many patients now own or have access to mobile computing devices having network and Internet connectivity capabilities, including laptop computers, tablet computers, personal digital assistants, cellular telephones, and smart phones, such as the iPhone®, iPod Touch®, and iPad® by Apple Inc. of Cupertino, Calif. Such mobile devices offer users a wide variety of features, including voice communication, e-mail, web browsing, address and contact books, calendaring and appointment scheduling, audio recorders and players, as well as access to an ever-growing library of customized applications. Furthermore, it is appreciated that a mobile device-based software application is one convenient mechanism for patients to receive information regarding their disease, schedule treatments, track progress towards a therapeutic goal, and communicate with support personnel, such as a case manager, in matters relating to their treatment.

Aspects of the disclosure are described in a general context of computer-executable instructions and may be embodied a general-purpose computer, such as a personal computer (PC), server computer, or other processor-based device. Aspects of the disclosure may also be embodied in a special-purpose computer, such as a personal digital assistant (PDA), mobile or cellular telephone (including “smart phones”), embedded processors, mainframe computers, multi-processing systems, distributed systems, and the like. The terms “computer,” “wireless device,” “mobile device,” and other terms describing any device that may be programmed, configured, or constructed to perform computer-executable instructions are used interchangeably and refer to any such device and system.

According to various embodiments, the disclosed techniques may be used by a patient to receive current information regarding their disease, schedule treatments, track progress towards a therapeutic goal, and communicate with support personnel, such as a case manager, in matters relating to their treatment using an application on their mobile device. In one embodiment, an application may be provided that integrates one or more of the above features in a single package that is easily and readily accessible to patients having such mobile devices. The disclosed techniques may be used, for example, by patients, family members, caregivers, healthcare professionals (e.g., health care providers), and case managers who are involved in the treatment of the patient. As used herein, “patient” refers to any user of the disclosed techniques, including the above-listed persons.

In one embodiment, an application is installed on the mobile device by downloading a program configured to execute on the processor of the mobile device from a third party service. For example, for the iPhone®, iPod Touch®, or iPad® mobile devices, the application may be downloaded from the well-known Apple Store® site using the well-known iTunes® application program by Apple Inc.

In one embodiment, an application is provided that includes a news feature. The news feature may allow current news articles or other educational information relevant to, for example, Gaucher disease, or other orphan diseases such as the diseases described herein, to be downloaded to the mobile device. For example, the news articles and other information may be related to the treatment of, for example, Gaucher disease, or other orphan diseases such as the diseases described herein, which treatment may include drugs or other therapies as disclosed herein. The information available for download may be pre-selected or authored by a third party, such as a provider of support services for the patient or a company, e.g., a company involved in the manufacture and/or distribution of a therapeutic treatment. The articles may be chosen for their timeliness and usefulness in assisting patients with on-going treatments of the disease.

The articles may be initially stored on a remote server and retrieved by the mobile device, either automatically or upon demand, whenever the mobile device is connected to a network, such as the Internet. Once retrieved, the articles may be stored on the mobile device for future access, even if the network connection is no longer available. In one example, the news feature allows the patient to retrieve and view a news feed provided from a website such as, for example, bravecommunity.com. Such websites may provide news or information about disease-related disorders, drug products, dietary recommendations, developments in medical research, case studies, profiles of patients, their families, and volunteers, advocacy efforts, legal issues, insurance, health care resources, and general advice relating to disease management or health care.

In another example, the news includes information provided by the support service or the company, e.g., a company involved in the manufacture and/or distribution of a therapeutic treatment, called company alerts, to be downloaded to the mobile device. The company alerts may contain information generated by, for example, the company relevant to a particular drug or therapy being used by the patient, e.g., a company which manufactures and/or distributes a therapeutic treatment and/or drug as described herein. Company alerts may be customized or triggered, for example, by information stored about the patient (e.g., the type of disease, type of treatment, prescribed drug). Alerts may be defined by the company, the user, or both.

In another example, headlines relating to the news articles and company alerts may be displayed on the mobile device, allowing the patient to select those headlines of interest. Upon selecting a headline, the corresponding full article or alert is displayed. Headlines may be customized or triggered, for example, by information stored about the patient (e.g., type of disease, type of treatment, prescribed drug), or by information stored about the viewing history of other headlines. For example, headlines may be selected for display on the device based on the disease being managed, the treatments being tracked, or headlines related to headlines previously viewed by the patient.

In another embodiment, an application is provided that includes a calendar feature. The calendar feature enables the patient to schedule treatments of the disease, for example, infusions of a drug, e.g., a drug described herein such as velaglucerase alfa. The treatments may be self-administered, administered by a family member, care giver, health care professional, or other person (e.g., a clinician at an infusion center or hospital). Treatments may be scheduled on a one-time or a recurring basis (e.g., bi-weekly). In one implementation, the calendar feature displays scheduled treatments on the mobile device for convenient review by the patient. The patient may add, modify, or delete any scheduled treatment using the user interface of the mobile device. In one example, treatment schedule templates may be provided (e.g., by the pharmaceutical company) having a predefined treatment schedule customized for the patient. Once selected, the treatment schedule may then be modified or deleted by the patient. In another example, treatment schedules for the patient may be reviewed by a case manager or health care provider for, e.g., compliance with a prescribed or recommended schedule.

In another example, the calendar feature enables the patient to schedule appointments to call or meet with a health care provider or case manager.

In another example, the patient may elect to share calendar information with a case manager, a health care provider, or other service provider. Scheduled treatments and appointments on the calendar are communicated to a health care provider or case manager for review. The health care provider or case manager may use this information to evaluate the course of treatment and recommend appropriate modifications. Further, compliance with, for example, a prescribed or recommended treatment schedule may be determined based on the calendar information.

In another embodiment, an application is provided that includes a tracking feature. The tracking feature may enable the patient to record and review certain treatment related data, including parameters that are commonly monitored during treatment of the disease. A parameter refers to a specific characteristic used to measure or indicate the effects or progress of a disease or condition, e.g., a disease or condition described herein. The data collected may be used, for example, to analyze progress toward a therapeutic goal established by a health care provider. Therapeutic goals may also be defined by the company that provides the drug or other medication used by the patient in the course of therapy. The data may, in some instances, be acquired through medical testing.

According to one embodiment, the data may be manually entered, or logged, into the application and stored on the mobile device or uploaded to a server. According to one example, the application may provide customized screens for entering, modifying, deleting, and viewing the data associated with one or more parameters relevant to the disease. Parameters relevant to various orphan diseases are described herein. For Gaucher disease, parameters may include, but are not limited to, bone pain, hemoglobin level, liver volume, platelet count, and spleen volume. The date on which each parameter was recorded may also be automatically stored. Additional information useful for managing treatments may also be stored, such as the age, weight, and gender of the patient. Any of the above data and information may be modified or deleted by the patient.

In another example, the tracking feature may enable the patient to display the stored (e.g., historical) data including the parameter values. The data may be displayed in a tabular format, for example, in a list showing each data point (e.g., biometric value) and the date on which the data point was evaluated and/or recorded. The data may be displayed in a graphical format to visually represent trends, for example, in a graph where individual data points are plotted against the corresponding recording date.

Frequently, a patient may be served by multiple health care providers, especially in the case of treating a chronic disease (e.g., an orphan disease such as a disease described herein). To this end, according to one embodiment, the patient may be provided tools to send personal treatment related data to different health care providers. The tools may include, for example, the ability to send the stored data to a case manager, who in turn may forward the data to an appropriate health care provider. In another example, the tools may include the ability to send the stored data directly to a health care provider.

In another example, the patient may elect to share parameter values and other health data with a health care provider or other service provider. The data are communicated to a health care provider or case manager for review. The health care provider or case manager may use this information to evaluate the course of treatment and recommend appropriate modifications. The data may include dosage and infusion information for one or more treatments, e.g., one or more treatments described herein.

In another example, the tracking feature may enable the patient to upload the stored (e.g., historical) data to a server, where it may be retrieved by a third party (e.g., a health care provider) for review. Because, according to one embodiment, the patient can more easily provide historical information that can be accessed by a health care provider, more accurate assessments and treatment may be given by the health care provider.

In another embodiment, an application is provided that includes a support feature. The support feature may be integrated with a third-party service provider that provides patient support services. Support services include, but are not limited to, providing advice and guidance regarding treatments to the patient (e.g., regarding self-administered infusions), arranging and coordinating insurance coverage for the drugs or other prescriptions used by the patient, arranging and coordinating reimbursement assistance for the drugs, prescriptions, and/or health care services used by the patient (e.g., co-pay reimbursement), and identifying treatment centers for the patient when he or she is traveling. For example, the support feature enables the patient to select a case manager from a list of available case managers. Case managers are persons who are assigned to provide support to the patient. The application may display a list of available case managers, along with biographical and contact information of the case manager, and allow the patient to select one case manager from the list. Contact information for the selected case manager may be used to facilitate communications between the patient and the case manager by, for example, automatically addressing messages composed by the patient to the selected case manager.

In another example, the support feature may enable the patient to exchange messages with the case manager. Messages may be composed on the mobile device and uploaded to a server, where they are subsequently routed to the case manager by e-mail or another messaging service. The application may provide one or more message templates to assist the patient in composing the message. For example, the templates may include customizable messages that allow the patient to notify the case manager of an address change, a change in insurance, a request for reimbursement of disease-related expenses, a scheduled appointment, or vacation plans. In another example, messages are automatically addressed to the case manager previously selected by the patient.

In another example, the support feature may enable the patient to store profile information, including, but not limited to, name, street address, telephone number, and e-mail address. The profile information may be automatically included in the messages sent to the case manager.

Exemplary Entity Relationships

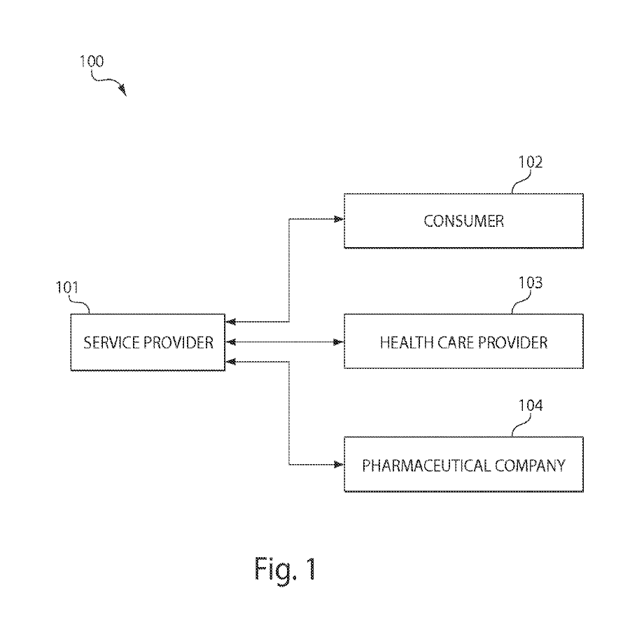

FIG. 1 illustrates exemplary relationships among entities 100 in which various embodiments of the disclosure can be utilized. A service provider 101 provides one or more services to one or more consumers 102, health care providers 103, and/or companies 104. Examples of services include providing health related news, company alerts and information, product support, and health care case management. One service provider 101 is the OnePath^{SM} service, which is a comprehensive and individualized support system for patients, families, and healthcare providers, provided by Shire HGT. Consumers 102 may include, for example, patients, family members of patients, and caregivers. Health care providers 103 may include, for example, physicians, registered nurses, ambulatory care facilities, and infusion centers. Companies 104 may include biotechnology and pharmaceutical companies, companies that, for example, develop, manufacture and/or market a drug or other therapeutic products. Service provider 101 may, in certain circumstances, be the same entity as health care provider 103 or company 104; however, for purposes of the present disclosure, service provider 101 is generally referred to as a separate functional entity even if service provider 101 is organizationally integrated with another entity.

The services provided by service provider 101 may include, but are not limited to, collecting and distributing news relevant to the treatment of a disease (e.g., a disease described herein) among consumers 102, health care providers 103 and pharmaceutical companies 104; facilitating the scheduling of certain medical treatments; tracking and monitoring health related data for individual patients, including parameter values; and facilitating individual communications, including exchanging messages between entities 100, various embodiments of which will be described in greater detail below. Service provider 101 may provide hosting services for various embodiments of the systems described herein, including the physical infrastructure of servers and communications services, or the hosting services may be provided by another entity.

According to an aspect, service provider 101 includes one or more case managers, who may be individuals specially-trained to assist patients and health care providers with the treatment of certain chronic diseases, such as Gaucher disease and other orphan diseases such as the diseases described herein, and the provisioning of other services, including insurance and reimbursement assistance. In one example, a case manager is assigned to a patient. The case manager may, among other tasks, assist the patient with arranging health insurance, arranging payment and/or reimbursement of costs associated with the treatment, answering questions about treatments, and locating an infusion center that is convenient for a patient, for example, a patient who is away from home (e.g., traveling). In another example, the case manager may assist the health care provider in recommending a course of therapy and/or identifying therapeutic goals for the patient.

### Exemplary Systems

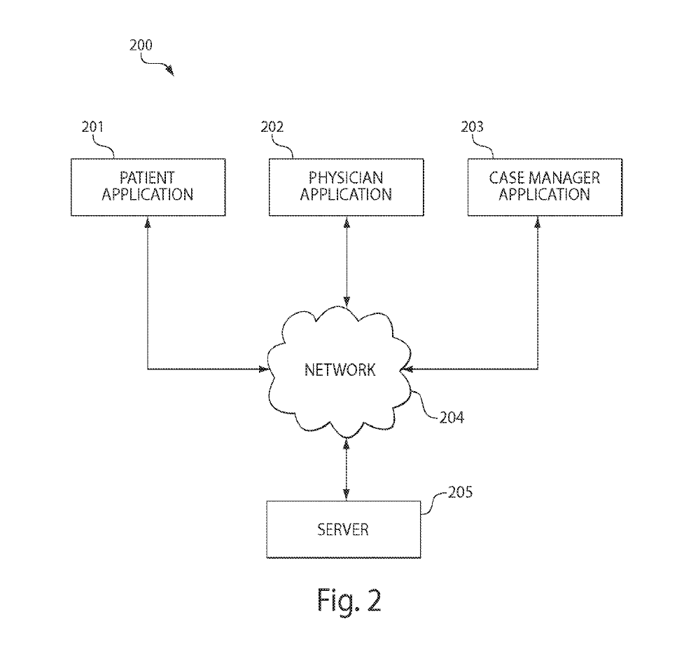

FIG. 2 illustrates an exemplary system 200 in accordance with one embodiment of the disclosure. System 200 includes a patient application 201, a physician application 202, and a case manager application 203. The term “physician application,” as used herein, refers to an application which may be used by a health care provider, including but not limited to a physician, nurse practitioner, or other qualified health care professional, and should not be construed strictly to physicians. Any of the applications 201, 202, or 203 may be installed and executed on a computer. The applications 201, 202, and 203 communicate data through a network 204 with at least one server 205. Network 204 may be the Internet, or may comprise any number of separate, interconnected and cooperative networks, such as intranets, wide-area networks, local area networks, and the like. Server 205 may be a single device, or a collection of devices, such as in a distributed processing system. In one embodiment, each application 201, 202, and 203 may operate as a stand-alone application where certain features are operational if the network communications are unavailable. For example, each a calendar of scheduled treatments may be stored locally (e.g., in a memory of a mobile device) and therefore is accessible to the user even in the absence of a network connection, for example, when the user is away from his or her home or office. Other features of the applications 201, 202, and 203 may depend upon server 205 to store, provide, and/or process data.

According to one embodiment, patient application 201 is used by a patient, family member, or caregiver to manage treatment of a chronic disease, e.g., an orphan disease such as a disease described herein. Patient application 201 may include a news feature, a calendar feature, a tracking feature, and a support feature, various embodiments of which will be described in greater detail below.

According to another embodiment, physician application 202 is used by a health care provider, such as a physician, nurse practitioner, or nurse, to manage treatment of a chronic disease, e.g., an orphan disease such as a disease described herein. Physician application 202 may include one or more of the following features: receive dosage and infusion information for a particular drug, e.g., a drug described herein; communicate with one or more patients using data generated by each patient; receive news related to the treatment of the chronic disease (e.g., the orphan disease such as the disease described herein) and information produced by a company regarding treatment of the disease; and receive support from a service provider, such as OnePath^{SM}.

In one embodiment, physician application 202 includes a dosage calculator for determining a dosage of a particular drug, and an infusion guide describing infusion procedures for the drug, for example, the infusion rates for intermittent subcutaneous injection and prolonged infusion. In one example, physician application 202 may display dosage and/or infusion information for one or more drugs or treatments, such as VPRIV® (velaglucerase alfa), REPLAGAL® (agalsidase alfa), and ELAPRASE® (idursulfase), each by Shire HGT.

In another embodiment, patients who are using a service provider, such as OnePath^{SM}, may elect to share clinical performance data and calendar data with their health care providers. By “opting-in” to such data sharing, health care providers may use, for example, physician application 202, to access the shared data. In one example, physician application 202 provides a “My Patients” tab for accessing shared data for each patient.

In another embodiment, physician application 202 may provide one or more of the features substantially as described below, such as a news feature, a calendar feature, a tracking feature, and a support feature. In yet another embodiment, physician application 202 may incorporate one or more other applications, such as a VPRIV® calculator by Shire HGT.

### Application Overview

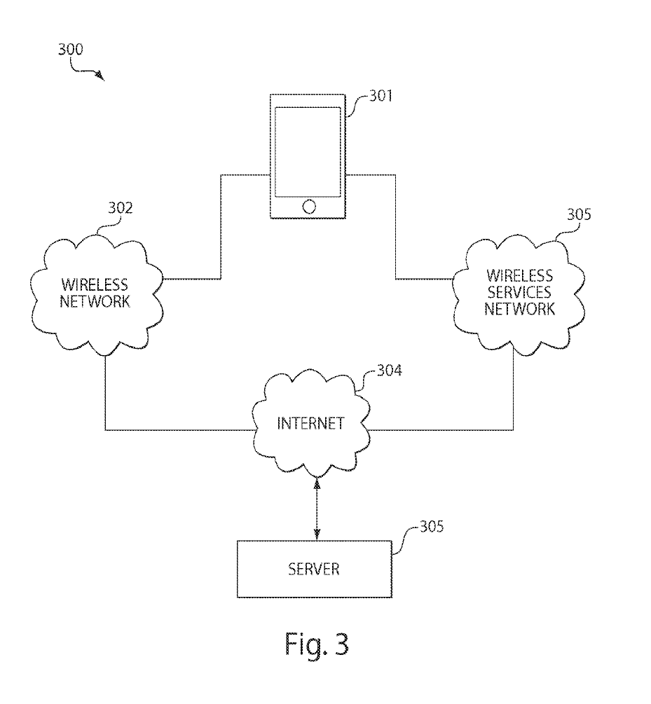

FIG. 3 illustrates an exemplary system 300 in accordance with one embodiment of the disclosure. System 300 is an example of a mobile device-based system for managing and tracking the treatment of a chronic disease, e.g., an orphan disease such as a disease described herein. However, system 300 may be implemented on other types of devices, such as PCs and PDAs.

In one embodiment, system 300 includes a mobile device 301 (e.g., smart phone, PDA, tablet computer, or wireless laptop) in communication with a wireless network 302 (through, for example, a Wi-Fi™ certified wireless local area network device based on the IEEE 802.11 standards). Mobile device 301 may execute a patient application or a physician application. Wireless network 302 provides a two-way communication path between mobile device 301 and the Internet 304. System 300 includes a server 305, which exchanges information with mobile device 301 through wireless network 302 and the Internet 304.

In another embodiment, mobile device 301 communicates with a wireless service network 303, for example GSM (global system for mobile communications), PCS (Personal Communications Service), UMTS (universal mobile telecommunication system), EDGE (enhanced data rates for GSM evolution), or CDMA (code division multiple access). Wireless service network 303 provides a two-way communication path between mobile device 301 and the Internet 304. System 300 includes a server 305, which exchanges information with the mobile device 301 through wireless service network 303 and the Internet 304.

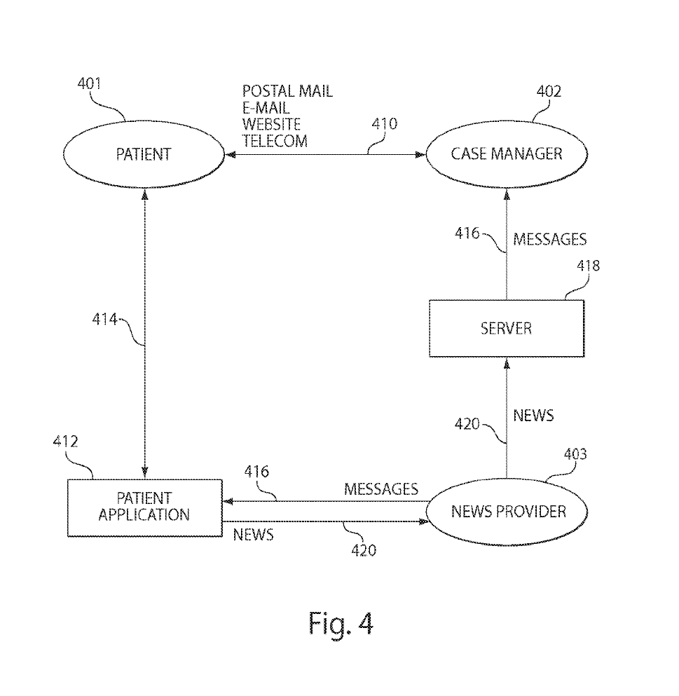

FIG. 4 illustrates an exemplary flow diagram showing the flow of data and other information within the systems illustrated in FIGS. 2 and 3. This and all other flow diagrams disclosed herein do not show all functions or exchanges of data, but are merely intended to provide a representative description of an exemplary system. It will be understood that certain functions, controls, data or other information may be supplemented, omitted, or varied in accordance with a particular application.

According to one embodiment, illustrated in FIG. 4 are several entities, including a patient 401, a case manager 402, and a news provider 403. Other entities may be included, such as a health care provider, family member, caregiver, or infusion center. Certain information and messages may be communicated between patient 401 and case manager 402 through a direct communication path 410. Direct communication path 410 may include postal mail, electronic mail, telephone, or a web site or other data exchange service.

Other information and messages may be communicated between patient 401 and case manager 402 through a patient application 412, implemented substantially as described above (e.g., on a smart phone or other mobile device). Patient 401 interacts with patient application 412 through a user interface 414, which may include graphical, textual, visual or audible components, to generate one or more messages 416. For example, user interface 414 may be implemented graphically using a touch screen input device and liquid crystal display (LCD) output device, such as found in the iPhone® or iPod Touch®. Patent application 412 sends messages 416 to a server 418, which in turn sends messages 416 to case manager 402.

News provider 403 generates news 420, which may include one or more news headlines, articles, or feeds and sends them to server 418. It will be understood that server 418 may be the same server or a different server as described above. Server 418 in turn sends news 420 to patient application 412, which patient 401 may retrieve and view through user interface 414.

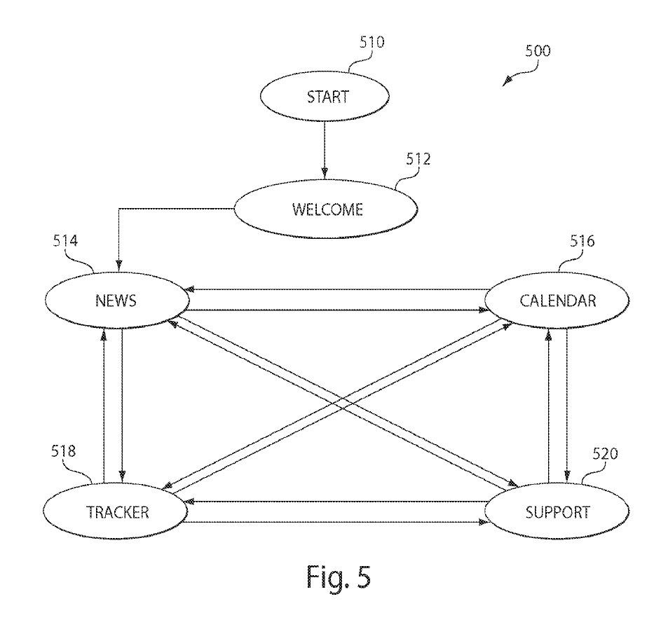

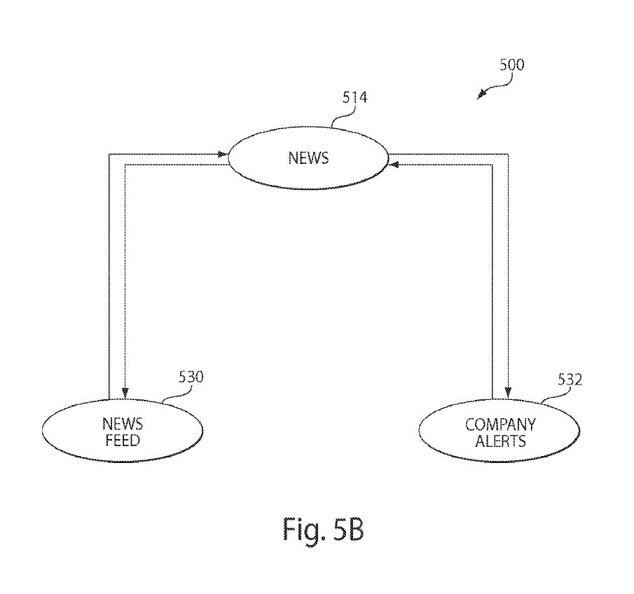

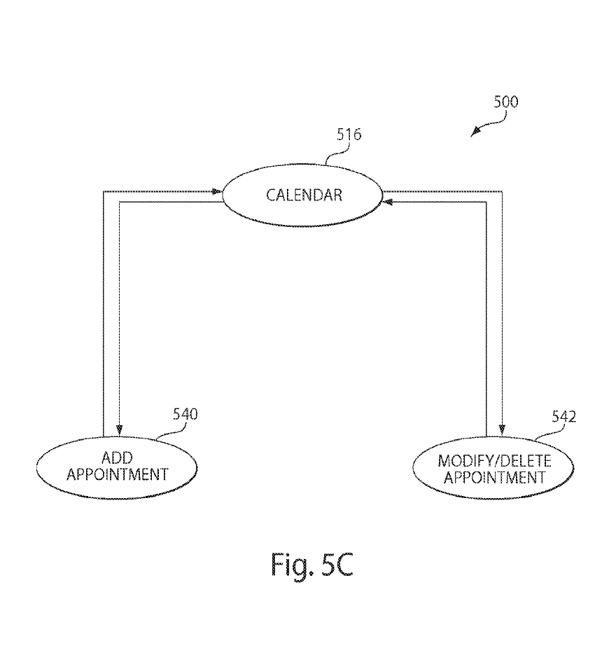

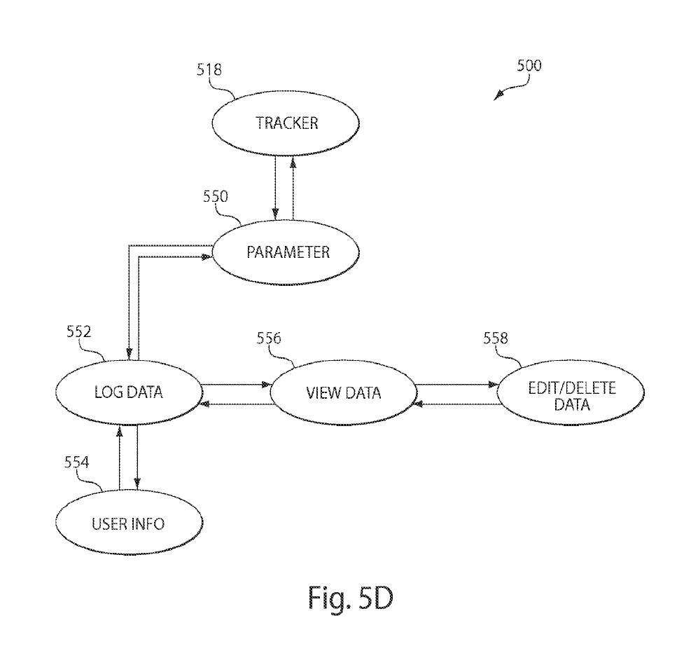

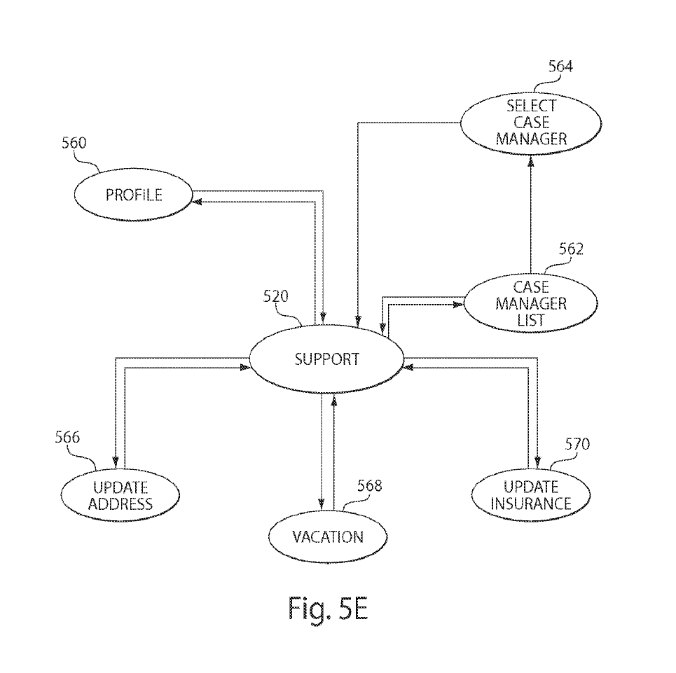

FIG. 5A illustrates a representative state diagram in accordance with one embodiment of a patient application 500. Patient application 500 may be a stand-alone application or may be integrated with an external service provider, such as OnePath^{SM}. Furthermore, patient application 500 may be executed, for example, by a smart phone, wireless mobile device, or PC. It will be understood that aspects of patient application 500 may be used by a patient, or by a health care provider, such as a physician, nurse practitioner or nurse, in conjunction with or independently from the patient. For example, certain features, such as the news feature, the calendar feature, the tracker feature, and the support feature, which are described in detail below, may be used by a health care provider in a physician application to monitor and manage the treatment of a patient who uses patient application 500.

According to one embodiment, patient application 500 may be implemented as a what-you-see-is-what-you-get (WYSIWYG) system. For example, patient application 500 may store, e.g., on a memory of the mobile device, data and information substantially as received from a server, entered by the user, or as displayed on the mobile device. In one example, a news article may be received from the server and stored on the memory. When the user requests the patient application 500 to display the news article, it is displayed substantially as it is stored, e.g., as a text document.

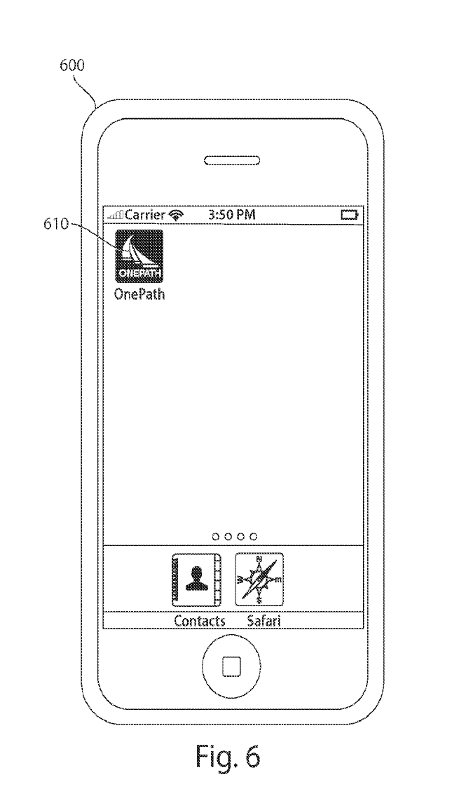

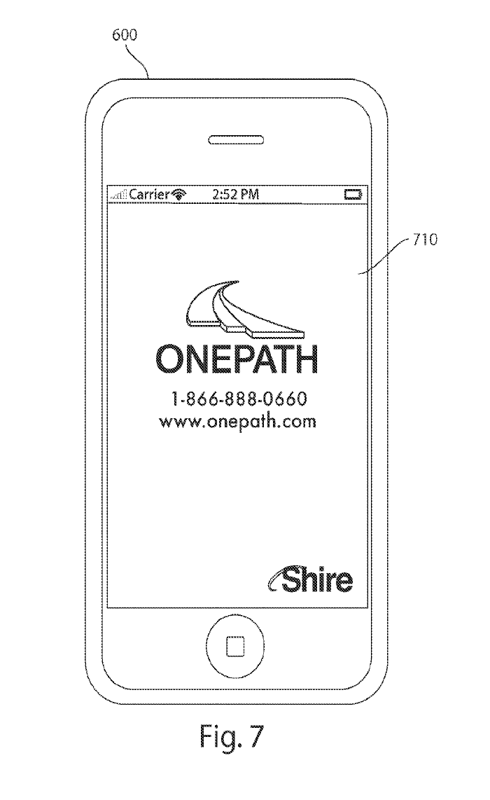

According to one embodiment, at block 510 patient application 500 is started or launched by a user (e.g. a patient). This may be accomplished by selecting an icon for application 500 on a display of a mobile device 600, as illustrated in FIG. 6. Once started, application 500 enters a welcome state 512. In welcome state 512, an application welcome or splash screen 710 may be displayed, as illustrated in FIG. 7. Welcome screen 710 may include information about application 500 and/or other information related to the service provider or mobile device 600.

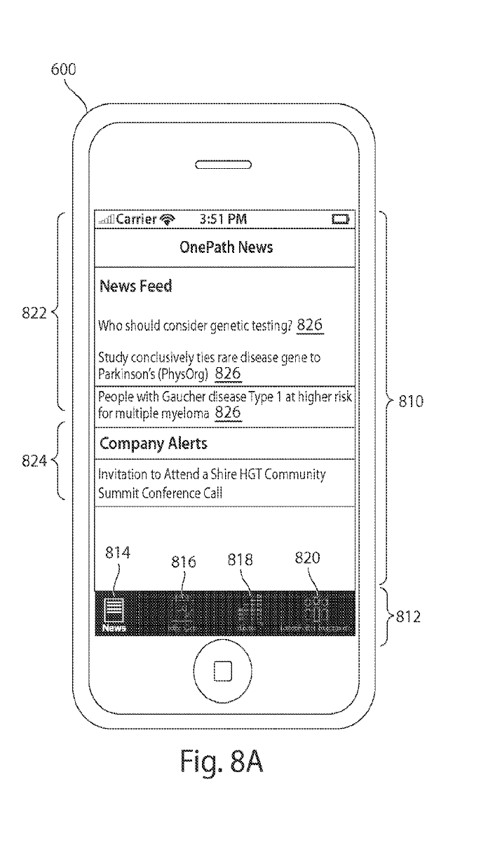

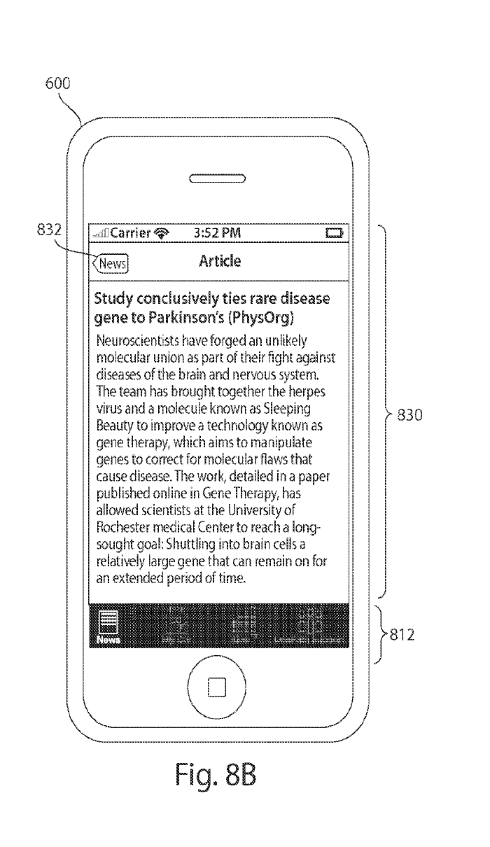

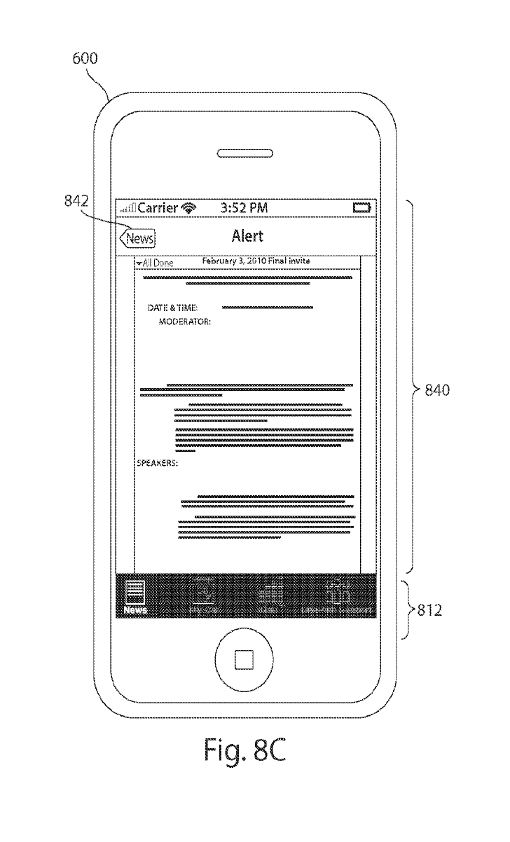

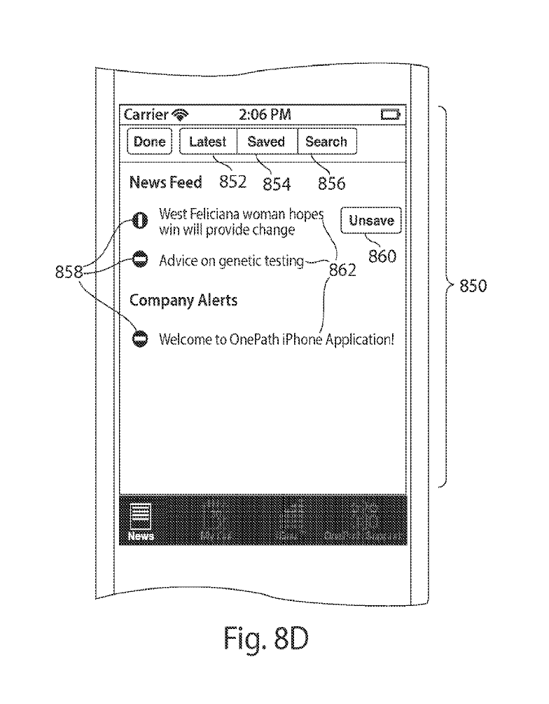

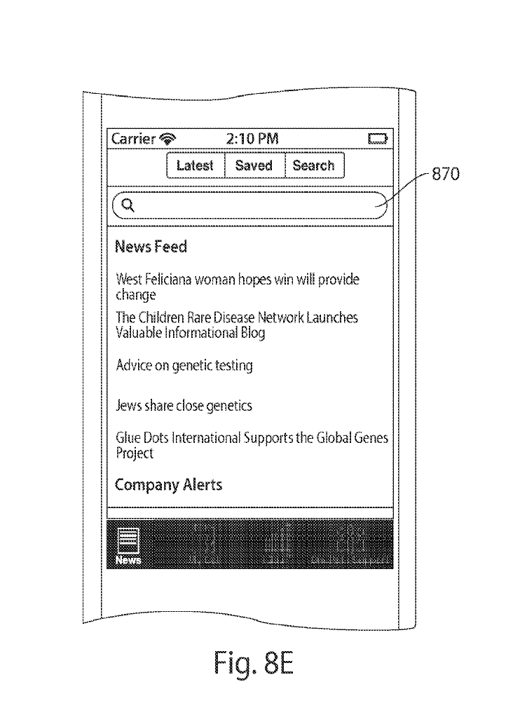

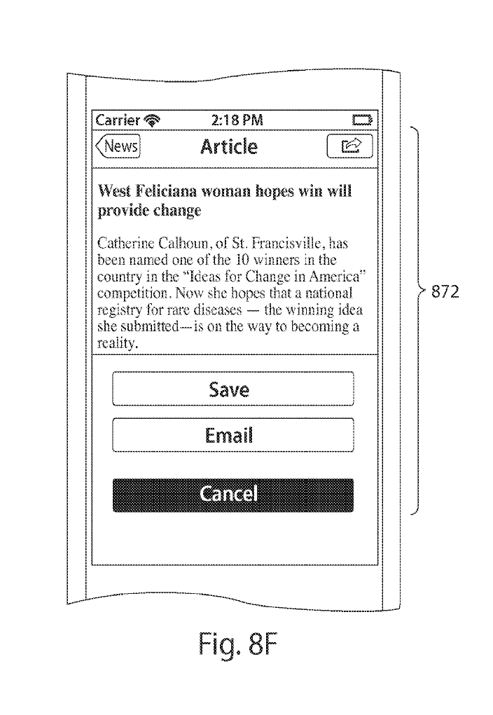

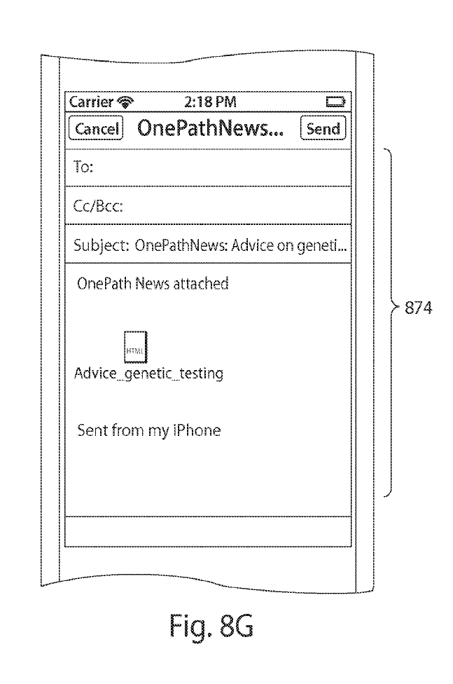

From welcome state 512 application 500 transitions to a news state 514. The transition may occur automatically, e.g., after a predetermined period of time has elapsed, or manually by the user, e.g., by touching the display of the mobile device 600. According to one example, in news state 514, a news screen 810 is displayed, as illustrated in FIG. 8A. As will be described in further detail below, news screen 810 may include a news feed and company alerts, among other information.

Below news screen 810 is a feature selector screen 812. It will be understood that feature selector screen 812 may be positioned anywhere on the display of mobile device 600. Furthermore, it will be understood that a feature selector may be implemented in other manners, for example through different screens or through a different user interface (e.g., buttons on mobile device 600 or voice command). Feature selector screen 812 may include icons representing one or more features of application 500, for example, news 814, calendar 816, tracker 818, and support 820. One or more of the features may be displayed, highlighted, hidden, or disabled (e.g., “grayed-out”). Other features may be represented by additional icons.

The user may select one of the features to transition to another state of application 500. For example, if the user selects calendar 816, application 500 transitions to a calendar state 516; if the user selects tracker 818, application 500 transitions to a tracker state 518; or if the user selects support 820, application 500 transitions to a support state 520. It will be understood that the states illustrated in FIG. 5A are exemplary, and that one or more of these states may be omitted, varied, or supplemented by additional states. Furthermore, it will be understood that the states enumerated above are merely exemplary, and that other states may be included in the application 500 to represent additional features.

### News

Each of the states enumerated above will now be described in further detail with respect to their corresponding features. In one embodiment, a news feature or module includes a news feed of information related to the chronic disease, such as Gaucher disease or other orphan disease such as the diseases described herein, to keep the patient updated on various events in the therapeutic area. For example, the information may include articles about disease-related disorders, drug products, dietary recommendations, developments in medical research, case studies, profiles of patients, their families, and volunteers, advocacy efforts, legal issues, insurance, health care resources, and general advice relating to disease management or health care. In another embodiment, the news feed may include news relating to a specific treatment used by the patient, such as the enzyme therapy velaglucerase alfa or other treatment described herein. In one embodiment, the news feed may include news related to velaglucerase alfa. It will be understood that the news function may contain other types of information that may be of interest to the patient or other user. In another embodiment, the news feature includes one or more company alerts, including information generated by, for example, the biotechnology or pharmaceutical company relating to products for treatment of the chronic disease (e.g., the orphan disease such as the disease described herein).

Application 500 may automatically download the news feed and/or company alerts from a server. The automatic download may occur at any time during execution of application 500. The user may also request application 500 to download the news feed and/or company alerts from the server (e.g., on demand refresh of news feed). The news feed and/or company alerts may reside in a database on the server. The news feed and/or company alerts may be used for other purposes, such as on a website (e.g., bravecommunity.com).

FIG. 5B illustrates a representative state diagram for the news feature in accordance with one embodiment of the patient application 500. In news state 514, news screen 810 is displayed, as illustrated in FIG. 8A. News screen 810 may include a news feed screen 822 and a company alerts screen 824, among other information. Within news feed screen 822 may be one or more news headlines 826. Within company alerts screen 824 may be one or more company alert headlines 828.

To view an article related to one of news headlines 826, the user may select one of news headlines 826 displayed in the news screen 810 by, for example, touching the display in the area where the headline is visible, or through another user input device (e.g., touchpad, mouse, keyboard, or voice command). When the user selects one of news headlines 826, application 500 transitions to a news feed state 530. In news feed state 530, news feed screen 830 is displayed, as illustrated in FIG. 8B. News feed screen 830 may include all or part of the article related to one of news headlines 826, or other information. The information displayed on news feed screen 830 may be textual and/or graphical (e.g., HTML-based content). The article or other information displayed on news feed screen 830 may be supplied by news provider 403, as illustrated in FIG. 4, or by another entity, for example, a company or other news service.

Optionally, feature selector screen 812 may be displayed below news feed screen 830 to enable the user to select a different feature of application 500 (e.g., calendar, tracker, or support).

To return to news screen 810, the user may select news icon 832. When the user selects news icon 832, application 500 transitions to news state 514.

To view an article related to one of company alert headlines 828, the user may select one of company alert headlines 828 displayed in news screen 810. When the user selects one of company alert headlines 828, application 500 transitions to a company alerts state 532. In company alerts state 532, company alerts screen 840 is displayed, as illustrated in FIG. 8C. Company alerts screen 840 may include all or part of the article related to one of company alerts headlines 828, or other information. The article or other information displayed on company alerts screen 840 may be supplied by news provider 403, as illustrated in FIG. 4, or by another entity, for example, a pharmaceutical company or other news service.

Optionally, feature selector screen 812 may be displayed below company alerts screen 840 to enable the user to select a different feature of application 500 (e.g., calendar, tracker, or support).

To return to news screen 810, the user may select news icon 842. When the user selects news icon 842, application 500 transitions to news state 514.

FIG. 8D illustrates another embodiment in which a news screen 850 includes a Latest News selector 852, a Saved News selector 854, a Search selector 856, a Saved Status indicator 858, and an Unsave Selector 860. In one example, if the user selects the Latest News selector 850, the system may sort the display of items in the news screen 850 according to date, for example, to show the latest or most recent news items first. In another example, if the user selects one or more news items 862 (including, for example, news feed items and company alert items, such as described above with respect to FIGS. 8A-8C) by selecting the Saved News selector 854, the system may save the selected news items into an archive for later retrieval. The save status of each news item 862 may be indicated by the Saved Status indicator; for example, a horizontal icon to indicate news items that are not saved and a vertical icon to indicate news items that are saved. The news items may, for example be saved locally on the device or remotely on a server. News items 862 that were previously saved may be “unsaved” by selecting the Unsave Selector 860.

FIG. 8E illustrates another embodiment in which news feeds may be searched by entering a search query into the search entry field 870. The user may, for example, enter a search query such as “infusion assistance,” and all news items stored locally on the device or remotely on a server will be searched accordingly by the system. The search may include searching a headline or body of each news item for terms that match or are similar to terms provided by the user in the search query. One or more results of the search may be displayed on the device.

FIG. 8F illustrates another embodiment in which news items may be saved and/or transmitted to another person using a user interface 872, such as through an electronic mail service. FIG. 8G shows another user interface 874 that may be used to enter addressee information and other information for the purpose of composing a message. The message may include the news item and/or other data that the user may optionally attach to the message.

### Calendar

In one embodiment, the calendar feature includes a calendar for organizing therapeutic treatments, such as infusions, and other disease related appointments, such as appointments with a health care provider or case manager.

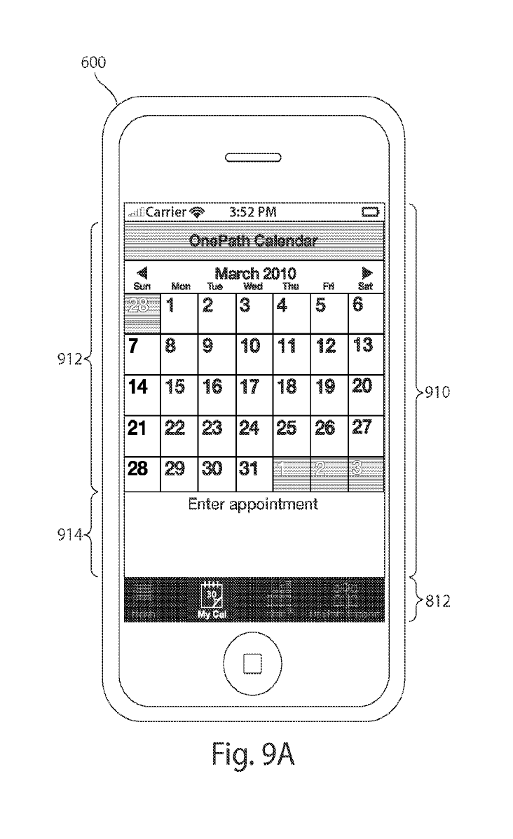

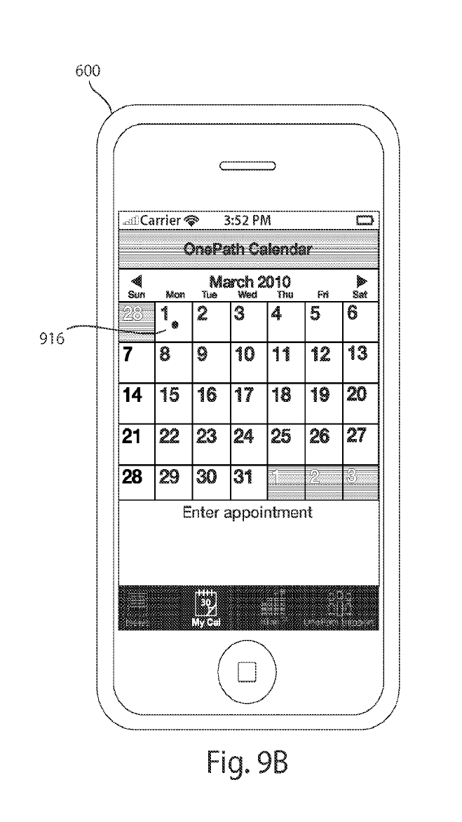

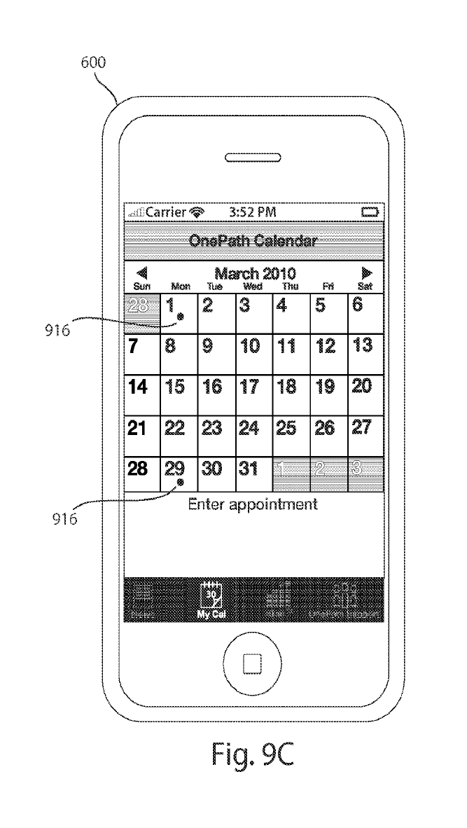

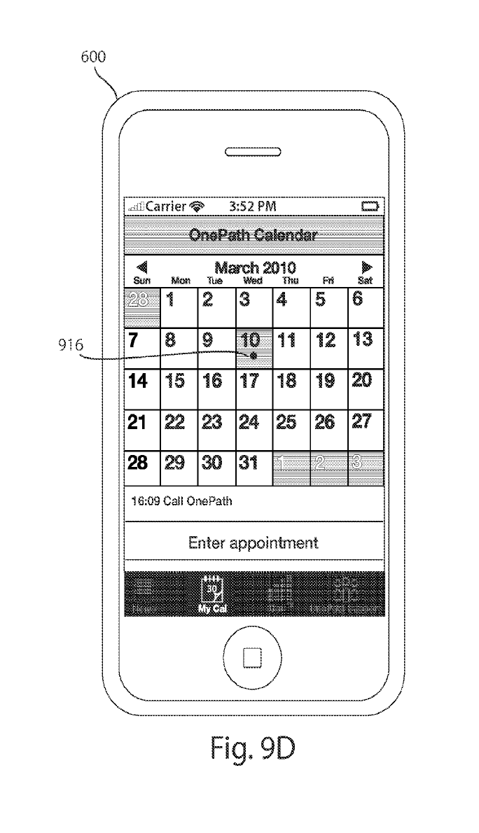

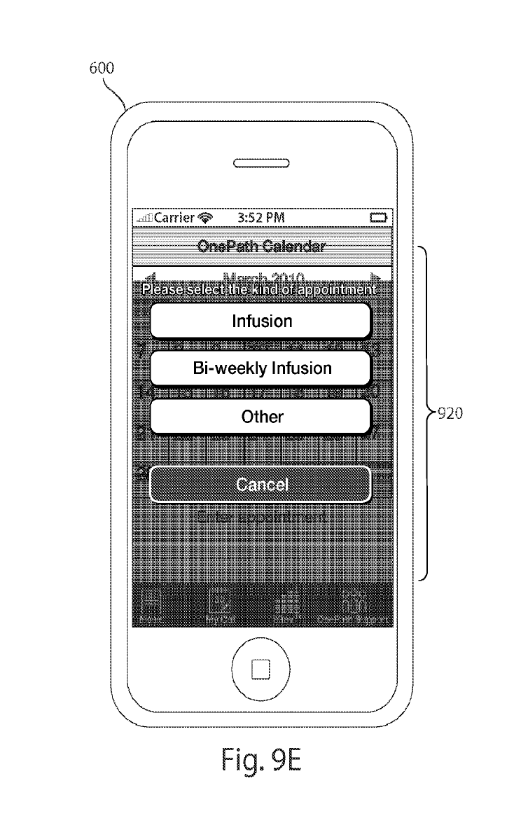

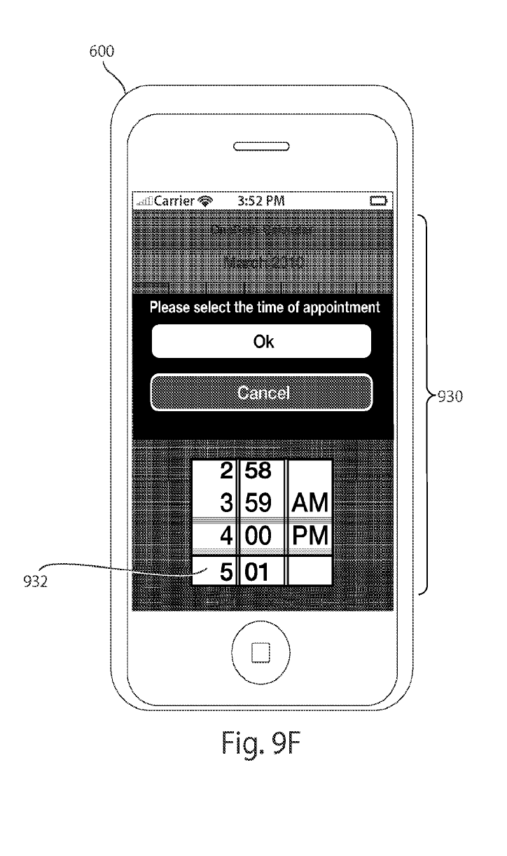

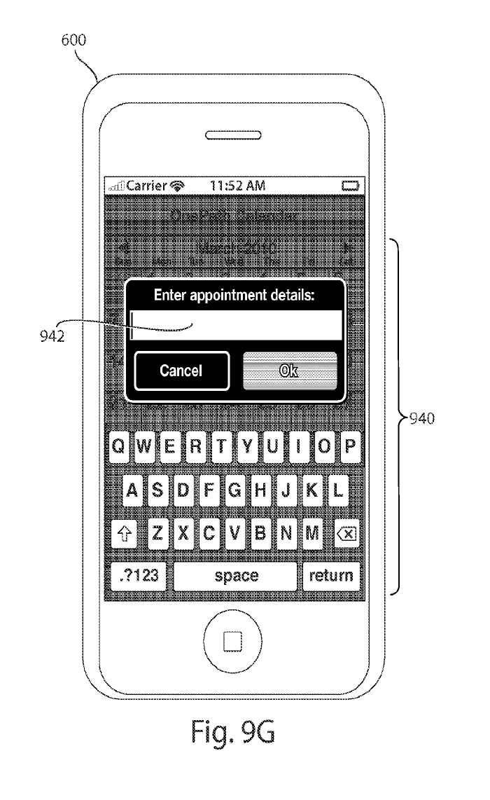

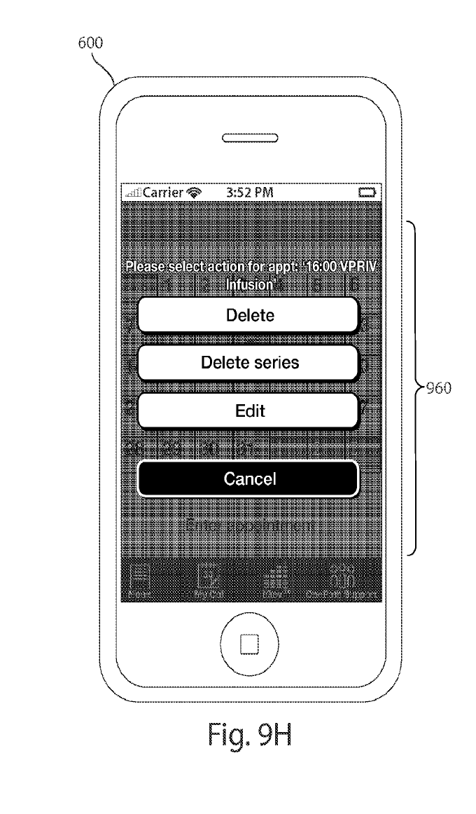

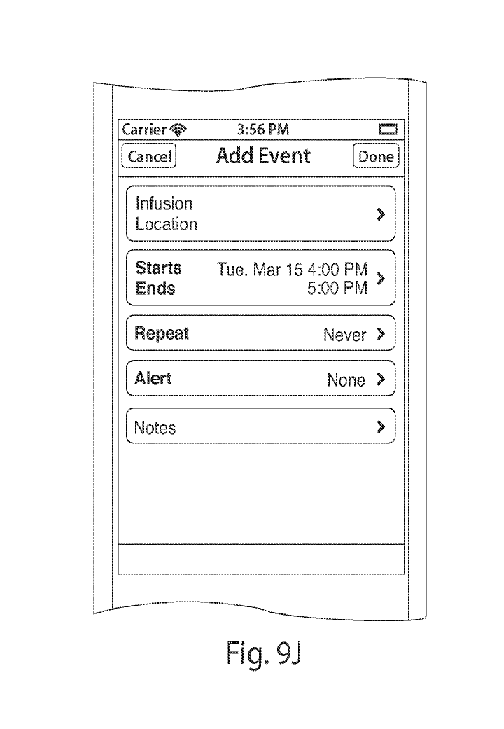

FIG. 5C illustrates a representative state diagram for the calendar feature in accordance with one embodiment of patient application 500. In calendar state 516, calendar screen 910 is displayed, as illustrated in FIG. 9A. Calendar screen 910 may include a date selector screen 912 and an appointment information screen 914, among other information. Within date selector screen 912 may be one or more dates. The dates may be shown in, for example, a daily, weekly, monthly, or yearly format. Within appointment information screen 914 may be one or more appointment details, such as a time of the appointment and other text describing the appointment. The appointment details may correspond to one or more of the dates selected by the user.

According to an embodiment, dates on which one or more appointments are scheduled may be displayed, for example, with a marker, such as a dot, or in a contrasting color (e.g., background or text color). In one example, as illustrated in FIG. 9B, a date 916 on which a one time infusion appointment is scheduled is displayed as a yellow tile having a dot within. In another example, as illustrated in FIG. 9C, multiple dates 916 on which a recurring, bi-weekly infusion appointment is scheduled are each displayed as yellow tiles having a dot within. In yet another example, as illustrated in FIG. 9D, a date 916 on which another type of appointment is scheduled is displayed as a blue tile having a dot within. It will be understood that the colors, symbols, styles, and other indicators used to identify and characterize scheduled appointments on the calendar may vary. It will also be understood that dosing regimens that can be scheduled on the calendar may vary.

To add an appointment to the calendar, the user may select one of the dates displayed on date selector screen 912 by, for example, touching the display in the area where the date is visible, or through another user input device. When the user selects one of the dates, application 500 transitions to an add appointment state 540.

In add appointment state 540, an appointment type selector screen 920 is displayed, as illustrated in FIG. 9E. Appointment type selector screen 920 may include several buttons or selectors representing various appointment types, such as infusion, bi-weekly infusion, or other. Appointment type selector screen 920 may include a cancel button or selector. To select an appointment type to be associated with the appointment being added, the user may select one of the various appointment types displayed on appointment type selector screen 920 by, for example, touching the display in the area where the button or selector is visible, or through another user input device. In one example, selecting “Infusion” will create a one-time infusion appointment for the selected date. In another example, selecting “Bi-weekly Infusion” will create recurring, bi-weekly appointments beginning on the selected date. In another example, selecting “Other” will create a one-time appointment for the selected date. Optionally, the user may select “Cancel” to terminate the addition of the appointment to the calendar, and application 500 transitions to calendar state 516.

If an appointment type is selected by the user, an appointment time selector screen 930 is displayed, as illustrated in FIG. 9F. Appointment time selector screen 930 may include several buttons or selectors for approving or terminating the addition of an appointment to the calendar. Appointment time selector screen 930 may include a time selector 932 for selecting a time of day. To select an appointment time to be associated with the appointment being added, the user may select, using time selector 932, the time of day for the appointment. In one example, selecting “4:00 PM” will create an appointment at 4:00 PM for the selected date (or multiple dates, if the appointment is recurring). When the time of day has been selected, the user may select “OK” to approve the selection, or “Cancel” to terminate the addition of the appointment, in which case application 500 transitions to calendar state 516.

If an appointment time is selected by the user, an appointment details screen 940 may be displayed, as illustrated in FIG. 9G. Appointment details screen 940 may include several buttons or selectors for approving or terminating the addition of an appointment to the calendar. Appointment details screen 940 may include a text entry box 942 for entering details related to the appointment being added. To add details to be associated with the appointment being added, the user may enter, using the text entry box, a text string using, for example, a virtual keyboard on the mobile device. In one example, entering “Call OnePath” will create an appointment having the detail “Call OnePath” for the selected date (or dates, if the appointment is recurring). When the details have been entered, the user may select “OK” to approve the entry, or “Cancel” to terminate the addition of the appointment. If the entry is approved, the appointment will be stored by application 500 (e.g., into the memory of the mobile device), and application 500 transitions to calendar state 516. If the entry is terminated, application 500 transitions to calendar state 516 without storing the appointment.

To modify or delete an appointment on the calendar, the user may select one of the dates, for which at least one appointment is scheduled, displayed on date selector screen 912 by, for example, touching the display in the area where the date is visible, or through another user input device. When the user selects one of the dates, application 500 transitions to a modify/delete appointment state 542.

In modify/delete appointment state 542, an appointment action selector screen 960 is displayed, as illustrated in FIG. 9H. Appointment action selector screen 960 may include several buttons or selectors representing various appointment action types, such as delete, delete series, or edit. Appointment type selector screen 960 may include a cancel button or selector. To select an action for the appointment on the selected date, the user may select one of the various appointment action types displayed on appointment type selector screen 960 by, for example, touching the display in the area where the button or selector is visible, or through another user input device. In one example, selecting “Delete” will delete a one-time appointment for the selected date. In another example, selecting “Delete series” will delete a recurring, bi-weekly appointment occurring on the selected date and all other dates in the recurring series of appointments, both past and future. In another example, selecting “Edit” will allow the user to change the details of a one-time or recurring appointment for the selected date. Optionally, the user may select “Cancel” to terminate the addition of the appointment to the calendar, and application 500 transitions to calendar state 516.

According to one embodiment, the patient may elect (“opt-in”) to share certain calendar data with a health care provider and/or service provider. For example, if the patient opts-in, infusion schedules may be communicated to a health care provider, who may use the schedules to provide medical advice to the patient. The schedules may be communicated, for example, by one or more messages sent through a server to the health care provider using a secure e-mail system. In another example, the schedules may be communicated through a server to a physician application for a mobile device configured to receive and display the schedules. Other methods of sharing the calendar data may be used.

### Tracker

In one embodiment, the tracker feature enables a patient to log and view one or more parameters and other medical data obtained from, for example, test results related to their disease, a health care provider or other source. For example, each parameter may include a parameter type, a parameter value, and a test date. In one embodiment, the patient has Gaucher disease and the parameter type can be, for example, one or more of: bone pain, hemoglobin level, liver volume, platelet count, and spleen volume.

According to another embodiment, one or more symptoms of the disease may be associated with the parameter type. For example, a symptom of an enlarged spleen may be associated with spleen volume; a symptom of an enlarged liver may be associated with liver volume; a symptom of a low platelet count may be associated with platelet count; a symptom of low hemoglobin level may be associated with hemoglobin level; and a symptom of bone pain may be associated with bone pain. It will be understood that these and other symptoms may be associated with one or more parameter types. The parameter value may be, for example, a quantitative measure of the corresponding parameter type (e.g., spleen volume measured in cubic centimeters). The test date may be, for example, the date on which the corresponding parameter type was measured or evaluated. Other health data may include, but is not limited to, weight, age, and gender of the patient, which may be used to determine specific therapeutic goals for the patient. In one embodiment, the parameters and other medical data may be entered by the user directly into the mobile device using, for example, a user interface of the device. In another embodiment, historical data may be imported into the mobile device from a file, database, or other data storage location through, for example, a wireless network device.

In yet another embodiment, the tracker feature enables the patient to record data associated with one or more treatments. For example, a patient using velaglucerase alfa may record the start and, if applicable, end dates of velaglucerase alfa treatment.

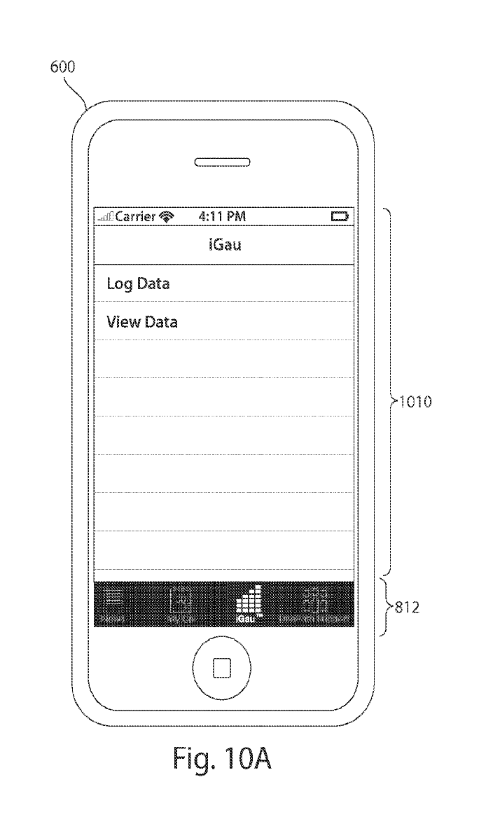

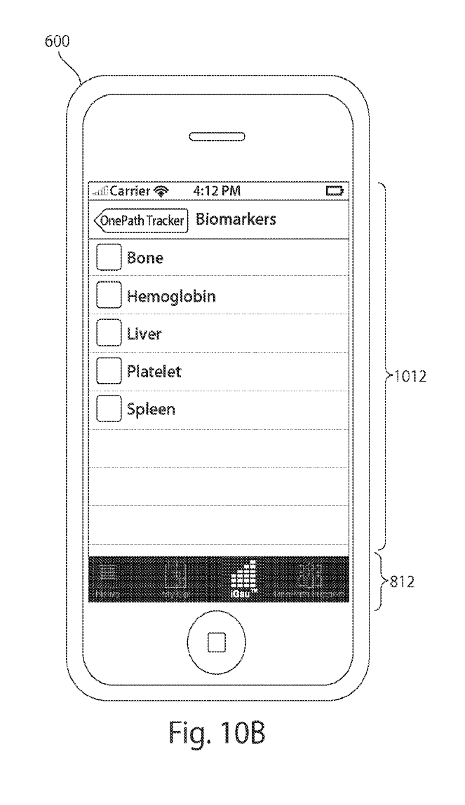

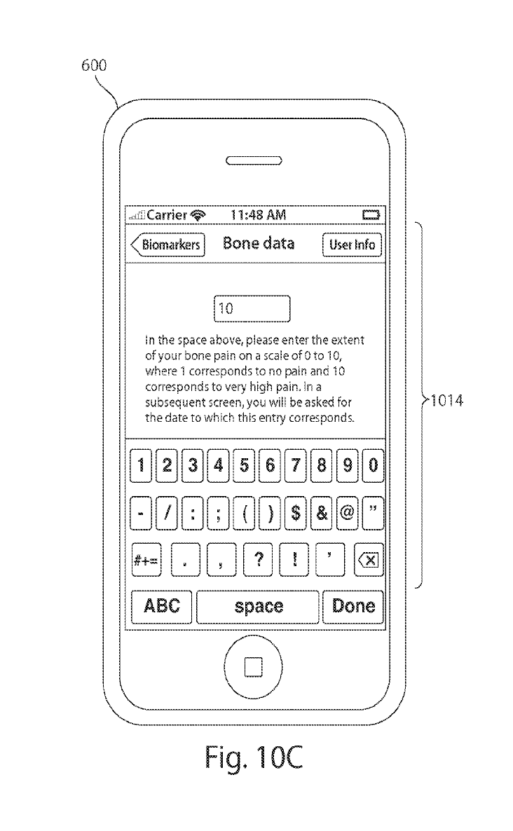

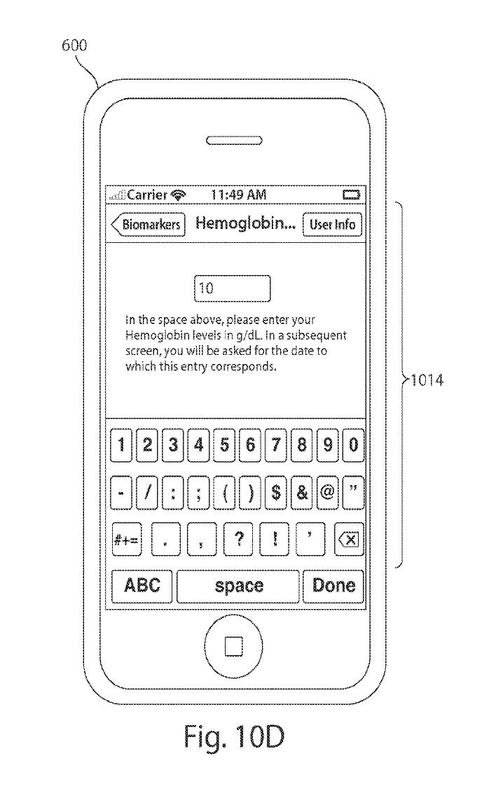

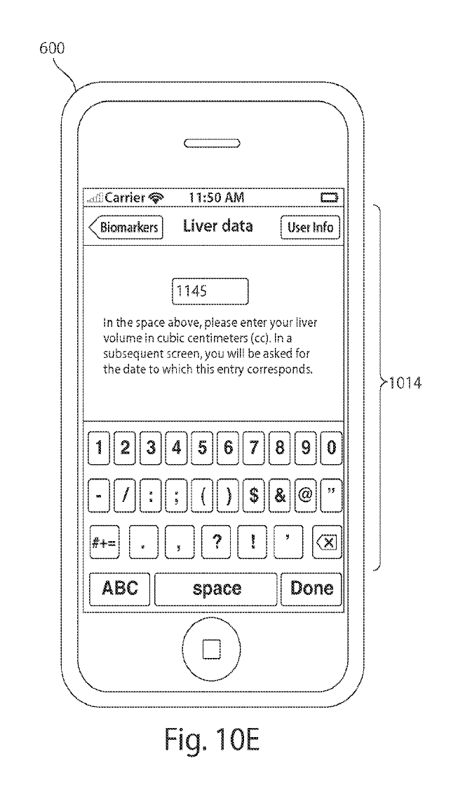

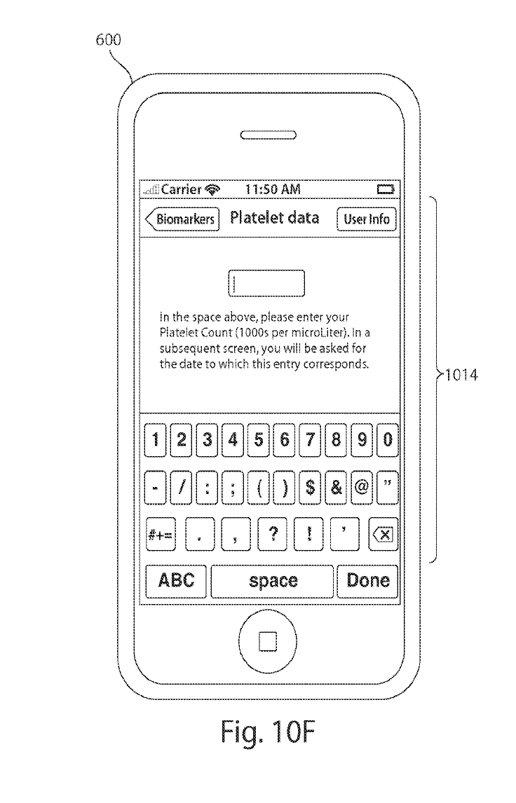

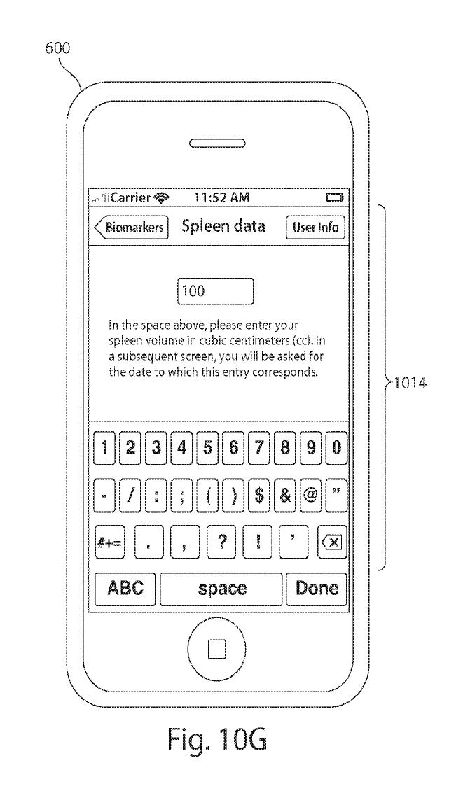

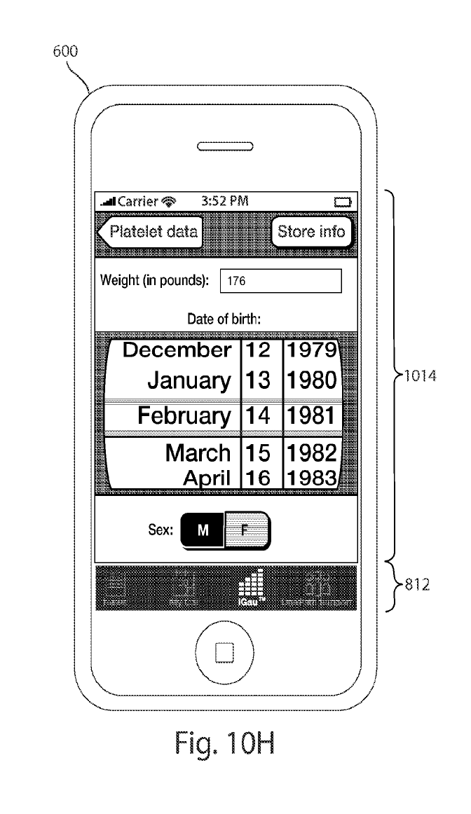

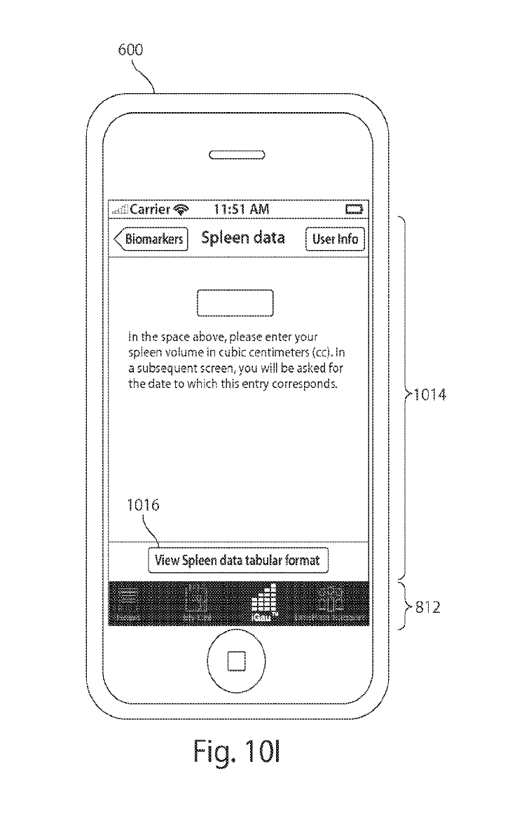

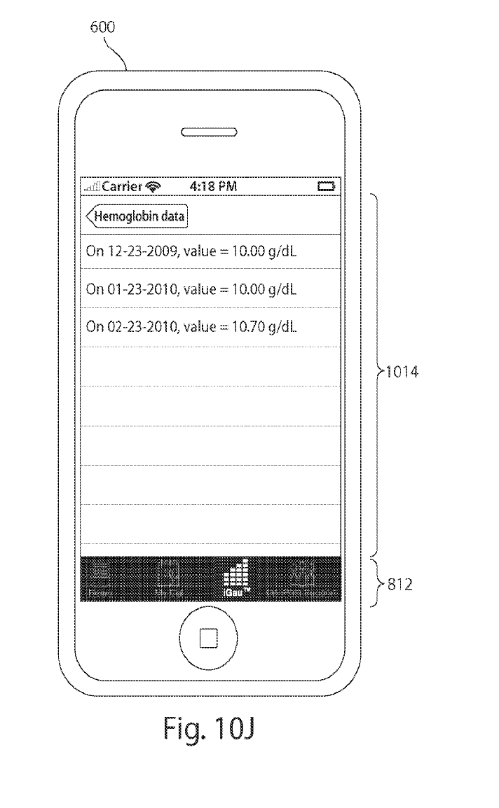

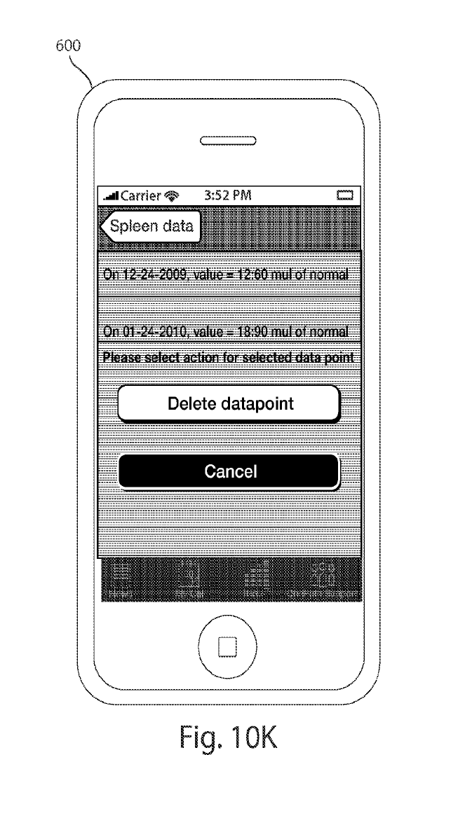

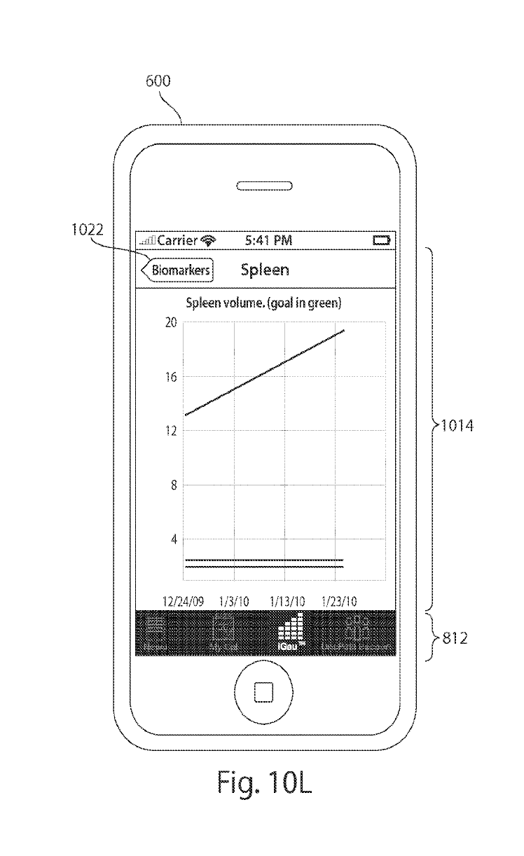

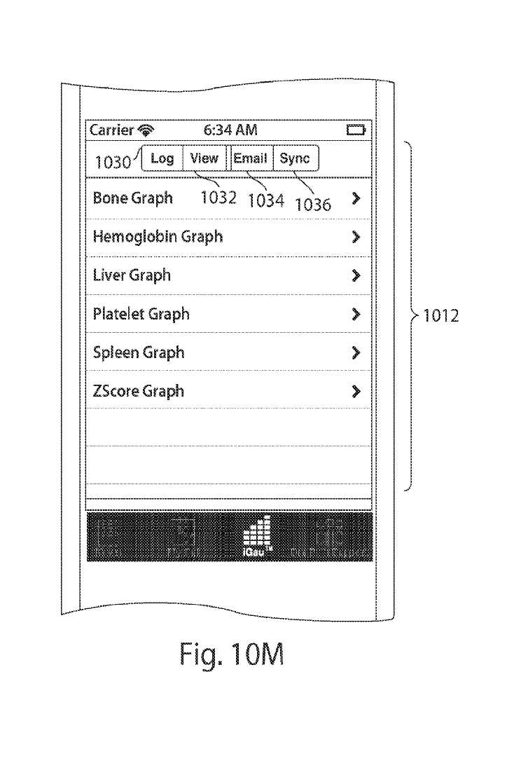

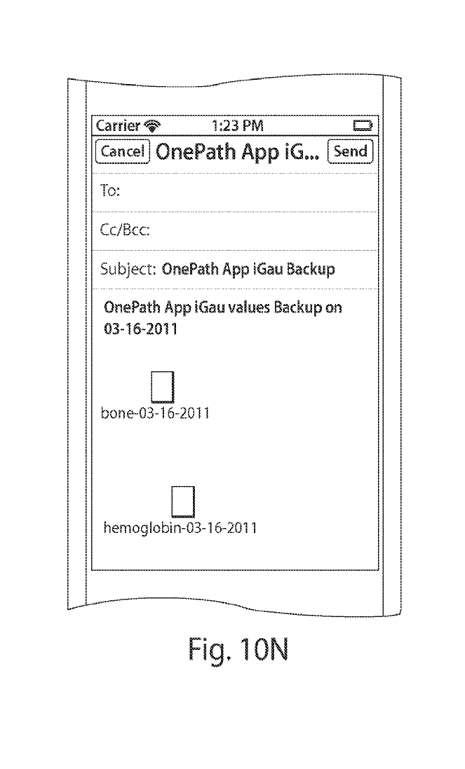

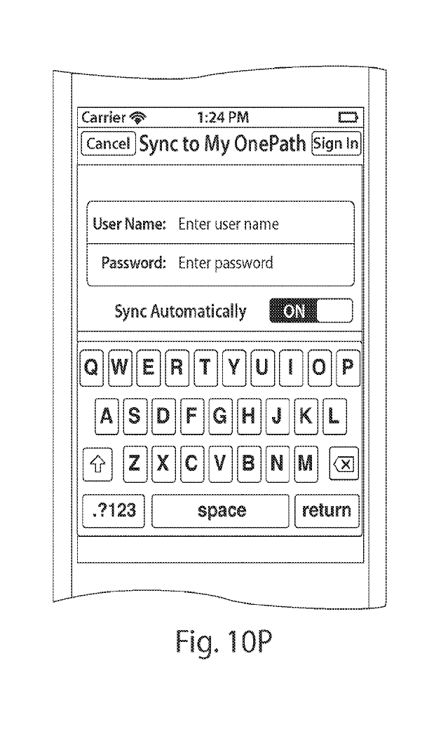

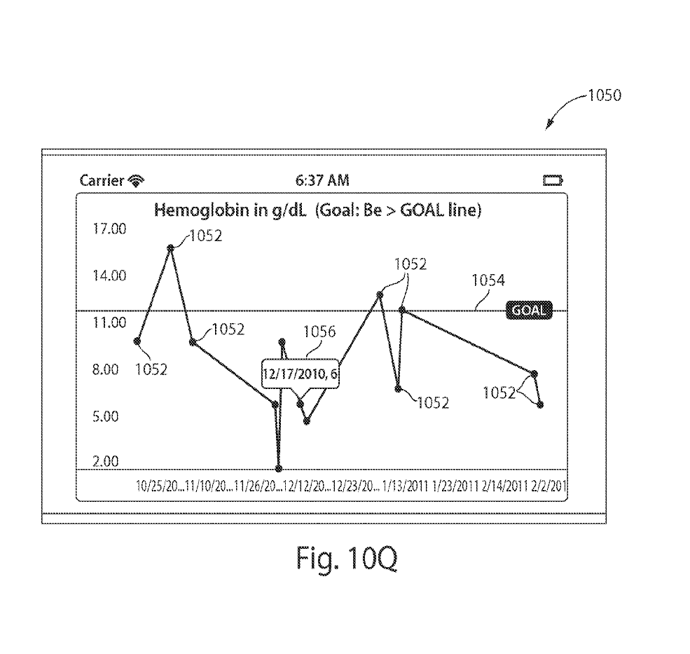

FIG. 5D illustrates a representative state diagram for the tracker feature in accordance with one embodiment of patient application 500. In tracker state 518, a tracker screen 1010 is displayed, as illustrated in FIG. 10A. Within tracker screen 1010 may be one or more options, including, but not limited to, log data and view data.

To log data in the tracker, the user may select “Log Data” displayed on tracker screen 1010 by, for example, touching the display in the area where the corresponding text is visible, or through another user input device. When the user selects “Log Data”, application 500 transitions to a parameter state 550. In parameter state 550, a parameter screen 1012 is displayed, as illustrated in FIG. 10B. Within parameter screen 1012 may be one or more options corresponding to various parameters, including, but not limited to, bone, hemoglobin, liver, platelet, and spleen. It will be understood that other parameters or data points may be included. It will also be understood that the parameter or parameters can vary depending on the disease. Parameters for various orphan diseases, such as lysosomal storage disorders, are known and described herein.

FIG. 10M illustrates another embodiment similar to that shown in FIG. 10B, except that the parameter screen 1012 includes a Log Selector 1030, a View Selector 1032, an E-mail Selector 1036, and a Synchronization Selector 1036. The Log Selector 1030 may be used to access the parameter state 550, such as described above with respect to FIGS. 15D and 10B. The View Selector 1032 may be used to access the view data state 556. The E-mail Selector 1036 may be used to electronically transmit the log data from the system to another person, for example, by electronic mail. One exemplary configuration user interface for transmitting log data is shown in FIG. 10N, which includes fields for enabling a user to enter an electronic mail address and/or other data.

The Synchronization Selector 1036 may be used, for example, to transmit the log data from the system to a remote server for archival, storage, or other purposes (including sharing the log data with a case manager or health care provider). Similarly, the log data may be received by the system from the remote server. An exemplary user interface for configuring the synchronization is shown in FIG. 10P, wherein the user may provide a username and/or password for synchronizing the log data with the remote server.

To log data for one parameter or other data point, the user may select the corresponding option displayed on parameter screen 1012 by, for example, touching the display in the area where the corresponding text is visible, or through another user input device. When the user selects a parameter or other data point, application 500 transitions to log data state 552. In log data state 522, a data entry screen 1014 is displayed, as illustrated in, for example, FIG. 10C, which shows an exemplary data entry screen 1014 for entering a data value for bone pain. It will be understood that data entry screen 1014 may be configured and arranged in other ways to provide for entry of data. For example, the data entry screen 1014 may be configured to enable the user to provide a ZScore, which is a number representing a bone mineral density z-score. The ZScore data may be subsequently displayed on the device, for example, as a graph or as a text listing.

To enter data for the selected parameter or other data point, the user may type the data into mobile device 600 using the touch screen or other user input device. For example, to enter a data corresponding to bone pain, the user first selects “Bone” from parameter screen 1012, as described above with respect to FIG. 10B. The user is then presented with a data entry screen 1014 customized to accept data pertaining to bone pain, as illustrated in FIG. 10C. The user may then enter the data corresponding to the bone pain parameter. The user may indicate that data entry is complete by selecting, for example, a “Done” button displayed on the screen. The data is then logged into the memory of mobile device 600 along with the current date and, optionally, the current time.

In another example, to enter data corresponding to hemoglobin level, the user first selects “Hemoglobin” from parameter screen 1012, as described above with respect to FIG. 10B. The user is then presented with a data entry screen 1014 customized to accept data pertaining to hemoglobin levels, as illustrated in FIG. 10D. The user may then enter data in a substantially similar manner to that described above with reference to bone pain. In other examples, data may be entered for other parameters or data points in a substantially similar manner, as illustrated in FIGS. 10E (liver volume), 10F (platelet count), and 10G (spleen volume).

According to one embodiment, in log data state 552, the user may enter data corresponding to certain physical attributes of the patient, including, but not limited to, weight, age, and gender. In one example, data entry screen 1014 may include a selector “User Info.” To enter information including, but not limited to, weight, date of birth, and gender, the user may select the “User Info” selector. When the user selects the “User Info” selector, application 500 transitions to a user info state 554. In user info state 554, a user information screen 1024 is displayed, as illustrated in FIG. 10H. User information screen 1024 may include one or more entry fields for entering the user information, such as a text box for entering weight, a date picker for selecting date of birth, and one or more buttons for selecting gender (e.g., “M” for male and “F” for female).

According to one embodiment, data entry screen 1040 includes a “View data in tabular format” button or selector 1016 to request viewing historical parameter data, as illustrated in FIG. 10I. When the user select the “View data in tabular format” button 1016, application 500 transitions to a view data state 556. In view data state 556, a tabular display 1018 of all data for the selected parameter is displayed, as illustrated in FIG. 10J. Each data point includes the parameter value and the date the parameter value was evaluated and/or recorded. Any of the data points may be edited or deleted by selecting the data point. When the user selects one of the data points, application 500 transitions to an edit/delete state 558. In edit/delete state 558, the user is presented with the option of editing or deleting the data point, for example, as illustrated in FIG. 10K. When the editing or deleting is complete, application 500 transitions to view data state 556.

According to another embodiment, data entry screen 1040 includes a “View data in graphical format” button or selector 1016 to request viewing historical parameter data. When the user selects the “View data in graphical format” button 1016, application 500 transitions to a view data state 556. In view data state 556, a graphical display 1020 of all data for the selected parameter is displayed, as illustrated in FIG. 10L. To exit graphical display 1020, the user may select the “Parameter” button or selector 1022, and application 500 transitions to parameter state 550.

FIG. 10Q shows a user interface 1050 for displaying log data according to another embodiment. In user interface 1050, log data is displayed as a series of data points 1052 that are connected by straight lines. The log data may be displayed in chronological order (e.g., by ascending dates corresponding to each data point 1052). A goal marker 1054 may optionally be displayed to indicate, relative to the data points 1052, a preset goal value (e.g., a therapeutic goal) associated with the type of data value displayed (e.g., hemoglobin in g/dL, as shown).

Further, a data balloon 1056 may be displayed for each of the data points 1052. Data balloon 1056 may include a data value associated with the respective data point 1052, a date associated with the data point 1052 (e.g., the date on which the data point was created or entered), or other relevant information. It should be appreciated that the user interface 1050 may be configured to display the data points 1052 in other ways, such as in a bar graph or pie chart. It should be further appreciated that the data may represent any type of data collected.

### Support

In one embodiment, the support feature includes various utilities that enable the user (e.g., patient) to choose a case manager and communicate with the selected case manager.

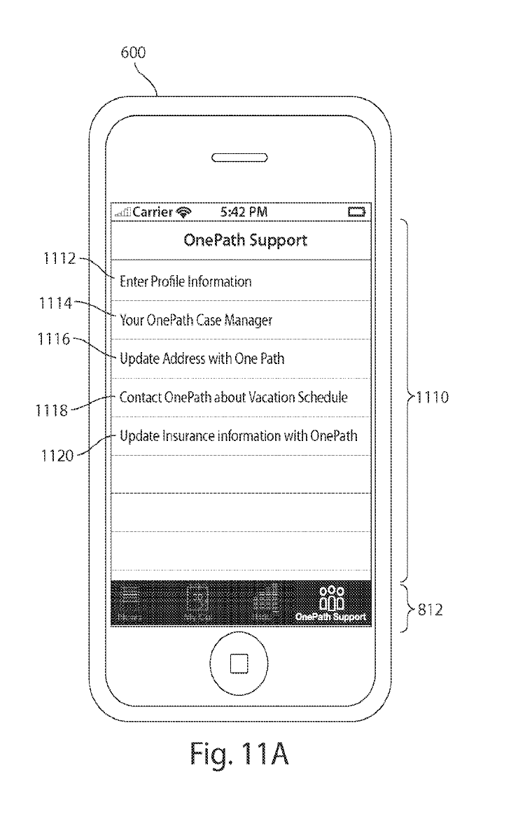

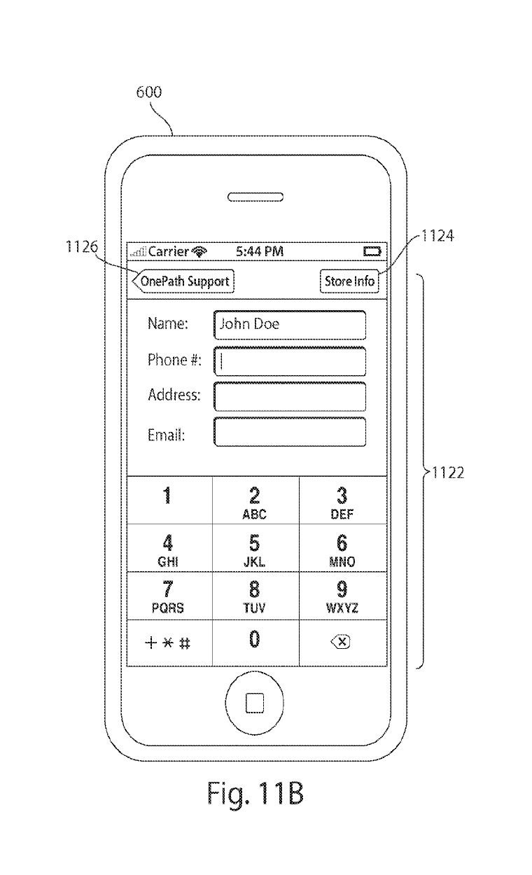

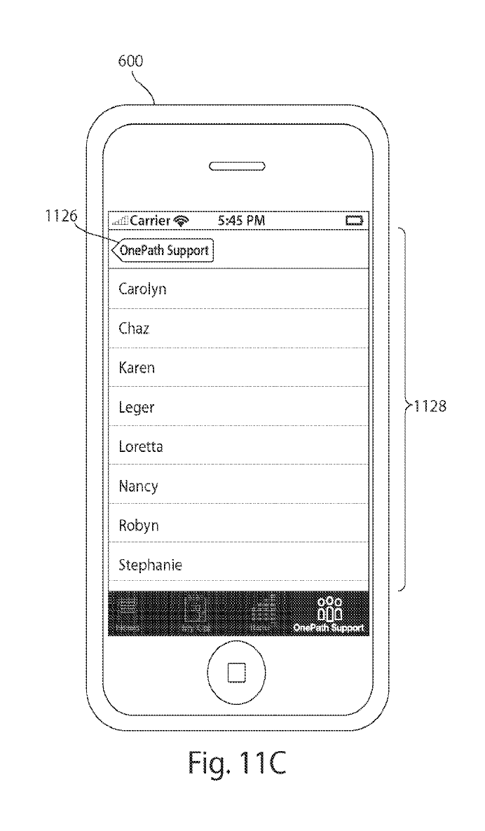

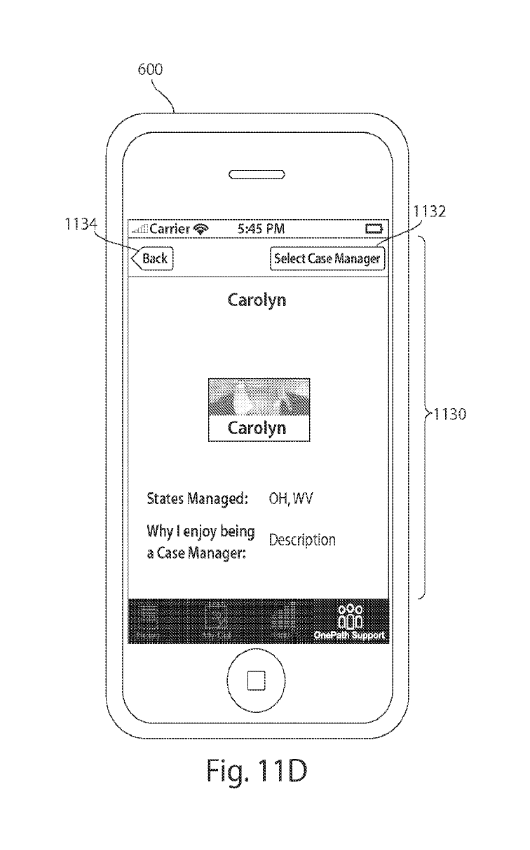

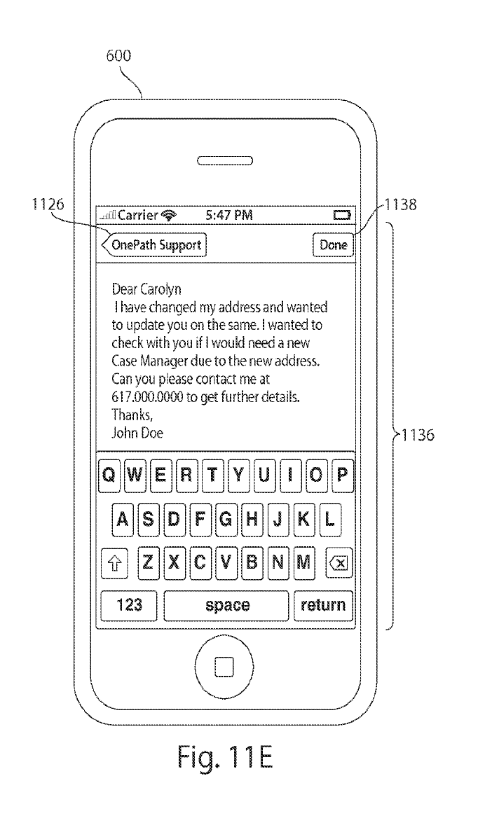

FIG. 5E illustrates a representative state diagram for the support feature in accordance with one embodiment of patient application 500. In support state 520, support screen 1110 is displayed, as illustrated in FIG. 11A. Support screen 1110 may display one or more of the following options: enter profile information 1112, case manager information 1114, update address 1116, vacation schedule 1118, and update insurance information 1120.

To enter, modify, delete or view profile information, the user may select enter profile information option 1112 on support screen 1110. When the user selects enter profile information option 1112, application 500 transitions to a profile state 560.

In profile state 560, a profile information screen 1122 is displayed, as illustrated in FIG. 11B. Profile information screen 1122 may include several text entry fields representing various profile data, such as name, phone number, street address, and e-mail address. If no profile data is stored, the corresponding entry field(s) will be blank; however, if profile data is stored, the existing profile data will be displayed in the corresponding field(s). The user may enter, modify or delete the profile data by selecting the appropriate entry field and entering or deleting the corresponding data in profile information screen 1122. When entry or modification is complete, the user may select a “Store Info” button 1124 to save the data, and application 500 returns to support state 520. Optionally, the user may choose to exit profile information screen 1122 without saving any changes by selecting a “Support” button 1126.

To select a case manager or view the selected case manager, the user may select case manager information option 1114 on support screen 1110. When the user selects case manager information option 1114, application 500 transitions to a case manager list state 562.

In case manager list state 562, a case manager list screen 1128 is displayed, as illustrated in FIG. 11C. Case manager list screen 1128 may include one or more names of case managers available to the patient. The user may select a name to view a biographical information screen 1130 including biographical information of the respective case manager, as illustrated in FIG. 11D. When the user selects one of the names, application 500 transitions to select case manager state 564.

In select case manager state 564, a biographical information screen 1130 is displayed including one or more items of biographical information for the case manager, including a name, a list of locations served by the case manager, and other information. The user may choose the case manager by selecting “Select Case Manager” button 1132, or the user may return to the case manager list screen 1128 by selecting “Back” button 1134. If the user chooses the case manager, application 500 stores the chosen case manger into the memory of the mobile device for future use, and transitions to support state 520. If the user elects to return to the list of case managers, application 500 transitions to case manager list state 562.

Before the user may communicate with a case manager, one must be chosen using, for example, the procedure described above. Once a case manager is chosen, the user may communicate with that case manager. For example, the user may wish to inform the case manager of an address change. The user may select update address option 1116 from support screen 1110. If the user chooses update address option 1116, application 500 transitions to an update address state 566.

In update address state 566, a message screen 1136 is displayed, as illustrated in FIG. 11E. In message screen 1136, application 500 may automatically generate a message template, including the name of the chosen case manager, the name of the patient, and other pertinent information. The user may optionally modify or delete the automatically generated text to customize the message. When the user has completed composing the message, the user may select “Done” button 1138. If the user selects “Done” button 1138, the message is communicated to the case manager by, for example, the techniques described above with reference to FIGS. 2-4. The user may optionally choose to cancel the operation by selecting “Support” button 1126. If the user selects either “Done” button 1138 or “Support” button 1126, application 500 transitions to support state 520.

In another example, the user may wish to inform the case manager of an upcoming vacation. The user may select vacation schedule option 1118 from support screen 1110. If the user chooses vacation schedule option 1118, application 500 transitions to a vacation state 568. In vacation state 568, the user may compose and send a message substantially as described above. Application 500 may automatically generate a message template appropriate for communicating vacation information to the case manager, which the user may modify.

In another example, the user may wish to inform the case manager of a change in insurance information, or request assistance from the case manager in an insurance-, payment-, or reimbursement-related matter. The user may select update insurance option 1120 from the support screen 1110. If the user chooses update insurance option 1120, application 500 transitions to an update insurance state 570. In update insurance state 570, the user may compose and send a message substantially as described above. Application 500 may automatically generate a message template appropriate for communicating an insurance-related message to the case manager, which the user may modify.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for managing treatment of an orphan disease of a patient by a user, the system comprising:
a mobile device including a processor and a memory coupled to the processor, the mobile device constructed and adapted to communicate with at least one server; and
a program stored on the memory, the program executable by the processor and comprising:
a data storage module for storing one or more parameters related to the treatment of the orphan disease;
a tracking module for tracking the one or more parameters; and
a communications module for communicating information related to the treatment of the orphan disease with at least one of a health care provider, a company, and a case manager.

2. The system set forth in claim 1, wherein the mobile device is one of a smart phone having a wireless network device and a personal digital assistant having a wireless network device.

3. The system set forth in claim 1, wherein the information includes at least one of news, company alerts, and the one or more parameters.

4. The system set forth in claim 1, the program further comprising a calendar module for scheduling at least one of treatment administrations and appointments.

5. The system set forth in claim 4, wherein the information includes at least one of the treatment administrations and the appointments.

6. The system set forth in claim 1, wherein at least one of the one or more parameters and the information is displayed to the user in an interface of the mobile device.

7. The system set forth in claim 1, wherein the orphan disease is a lysosomal storage disorder.

8. The system set forth in claim 1, wherein the treatment includes at least one of enzyme replacement therapy, bone marrow transplantation, physical therapy, cord blood transplants, anticonvulsant medicine, adequate nutrition and hydration, techniques to keep airway open, gene therapy, controlling or reducing the symptoms associated with the orphan disease, nutrition supplements, physical therapy, speech therapy, surgery, cysteamine, sodium citrate, potassium and phosphorus supplements, conventional antipsychotic or antidepressant therapy, lithium salts, electroconvulsive therapy, spinal fusion, glucosylceramide synthase inhibitors, organ transplant, palliative treatment, a glycosylation independent lysosomal targeting (GILT) tagged human acid alpha-glucosidase (GAA), agalsidase beta, metoclopramide, dialysis, kidney transplantation, velaglucerase alfa, taliglucerase alfa, glucosylceramide synthase inhibitors, isofagomine tartrate, blood transfusion, joint replacement surgery, antibiotics, antiepileptics, bisphosphonates, substrate reduction therapy, corneal transplants, N-butyldeoxynojirimycin, proper nutrition and hydration, maintenance of clear airways, anticonvulsants, stem cell treatment, growth hormones, dental hygiene, physiotherapy, and hydrotherapy.

9. The system set forth in claim 1, wherein the one or more parameters includes parameter data acquired from a medical test of the patient.

10. The system set forth in claim 1, wherein the one or more parameters includes a parameter type, a parameter value, and a test date.

11. The system set forth in claim 10, wherein the parameter type is one of bone pain, hemoglobin level, liver volume, platelet count, and spleen volume.

12. A method for managing treatment of an orphan disease of a patient by a user using a mobile device, the method comprising:
storing, on a memory of the mobile device, one or more parameters related to the treatment of the orphan disease;
tracking the one or more parameters; and
communicating information related to the treatment of the orphan disease with at least one of a health care provider, a company, and a case manager.

13. The method set forth in claim 12, wherein the mobile device is one of a smart phone having a wireless network device and a personal digital assistant having a wireless network device.

14. The method set forth in claim 12, wherein the information includes at least one of news, company alerts, and the one or more parameters.

15. The method set forth in claim 12, further comprising scheduling at least one of treatment administrations and appointments.

16. The method set forth in claim 15, wherein the information includes at least one of the treatment administrations and the appointments.

17. The method set forth in claim 12, further comprising displaying, to the user in an interface of the mobile device, at least one of the one or more parameters and the information.

18. The method set forth in claim 12, wherein the orphan disease is a lysosomal storage disorder.

19. The method set forth in claim 12, wherein the treatment includes at least one of enzyme replacement therapy, bone marrow transplantation, physical therapy, cord blood transplants, anticonvulsant medicine, adequate nutrition and hydration, techniques to keep airway open, gene therapy, controlling or reducing the symptoms associated with the orphan disease, nutrition supplements, physical therapy, speech therapy, surgery, cysteamine, sodium citrate, potassium and phosphorus supplements, conventional antipsychotic or antidepressant therapy, lithium salts, electroconvulsive therapy, spinal fusion, glucosylceramide synthase inhibitors, organ transplant, palliative treatment, a glycosylation independent lysosomal targeting (GILT) tagged human acid alpha-glucosidase (GAA), agalsidase beta, metoclopramide, dialysis, kidney transplantation, velaglucerase alfa, taliglucerase alfa, glucosylceramide synthase inhibitors, isofagomine tartrate, blood transfusion, joint replacement surgery, antibiotics, antiepileptics, bisphosphonates, substrate reduction therapy, corneal transplants, N-butyldeoxynojirimycin, proper nutrition and hydration, maintenance of clear airways, anticonvulsants, stem cell treatment, growth hormones, dental hygiene, physiotherapy, and hydrotherapy.

20. The method set forth in claim 12, wherein the one or more parameters includes parameter data acquired from a medical test of the patient.

21. The method set forth in claim 12, wherein the one or more parameters includes a parameter type, a parameter value, and a test date.

22. The method set forth in claim 21, wherein the parameter type is one of bone pain, hemoglobin level, liver volume, platelet count, and spleen volume.

23. The method set forth in claim 12, further comprising displaying the one or more parameters on a display of the mobile device.

24. A computer readable storage medium embodying a program including instructions executable by a processor of a mobile device to execute the method of claim 12.

25.-26. (canceled)

27. A system for managing treatment of an orphan disease of a patient by a user, the system comprising:
a mobile device including a processor and a memory coupled to the processor, the mobile device constructed and adapted to communicate with at least one server; and
a program stored on the memory, the program executable by the processor and comprising:
a news module for receiving and displaying news related to the orphan disease, the news to be generated by a news provider and disseminated through the at least one server;
a calendar module for scheduling treatments of the orphan disease and/or health related appointments;
a tracking module for storing and displaying health related data of the patient; and
a support module for exchanging messages between the patient and a case manager through the at least one server.

28. The system set forth in claim 27, wherein the mobile device is one of a smart phone having a wireless network device and a personal digital assistant having a wireless network device.

29. The system set forth in claim 27, wherein the news module provides at least a news screen for displaying one or more headlines, a news feed screen for displaying a news story, and a company alert screen for displaying information generated by at least one of a company and a support service.

30. The system set forth in claim 27, wherein the calendar module stores and displays at least one appointment related to the treatment of the orphan disease.

31. The system set forth in claim 30, wherein the at least one appointment is at least one of a one time appointment and a bi-weekly appointment.

32. The system set forth in claim 27, wherein the health related data includes parameter data acquired from a medical test of the patient.

33. The system set forth in claim 32, wherein the parameter data includes a parameter type, a parameter value, and a test date.

34. The system set forth in claim 33, wherein the orphan disease is a lysosomal disease, and wherein the parameter type is one of bone pain, hemoglobin level, liver volume, platelet count, and spleen volume.

35. The system set forth in claim 27, wherein the tracking module further stores and displays a weight, an age, and a gender of the patient.

36. The system set forth in claim 27, wherein the tracking module displays parameter data in at least one of a tabular and a graphical format.

37. The system set forth in claim 27, wherein the support module stores and displays a list of case managers, the list of case managers including at least a plurality of case manager names.

38. The system set forth in claim 37, wherein the support module stores and displays a patient profile, the patient profile including a patient name, a patient street address, a patient telephone number, and a patient e-mail address.

39. The system set forth in claim 37, wherein the support module generates the messages based on the patient profile, the case manager, and a message type.

40. The system set forth in claim 39, wherein the message type is one of address change notification, insurance notification, and vacation notification.

41. A method for managing treatment of an orphan disease of a patient by a user using a mobile device, the method comprising:
scheduling, in a calendar stored on the mobile device, one or more appointments related to the treatment of the orphan disease; and
tracking, in a repository stored on the mobile device, one or more parameters acquired from a medical test of the patient, each of the one or more parameters including a parameter type, a parameter value, and a test date.

42. The method set forth in claim 41, further comprising receiving, through a network interface of the mobile device, and displaying, through a graphical user interface of the mobile device, one or more news items related to the orphan disease.

43. The method set forth in claim 42, wherein each of the one or more news items includes at least one of a news story and a company alert.

44. The method set forth in claim 41, further comprising communicating, through the network interface, one or more messages between the patient and a case manager.

45. The method set forth in claim 41, wherein each of the one or more appointments includes one of a one time appointment and a recurring appointment.

46. The method set forth in claim 41, wherein tracking one or more parameters includes:
prompting a user to select a parameter type;
in response to the parameter type being selected, prompting the user to enter the parameter value, the parameter representing a discrete measurement of one parameter of the patient;
in response to the parameter value being entered, storing the parameter type, the parameter value, and the test date in the repository;
prompting the user to request a history of the one or more parameters; and
in response to the history being requested, retrieving at least one of the one or more parameters from the repository, and displaying the retrieved parameter in a tabular or graphical format.

47. The method set forth in claim 41, wherein any one of the one or more messages is at least one of an address change notification, an insurance notification, and a vacation notification.
